(19) United States
(12) Patent Application Publication
(10) Pub. No.: US 2004/0079248 A1
(43) Pub. Date: Apr. 29, 2004

(54) Printer capable of printing simultaneously on both sides of the page

(76) Inventors: Yaron Mayer, Jerusalem (IL); Al J.C. Baur, Kibbutz Ramat Hasshofet (IL); Haim Gadassi, Jerusalem (IL)

Correspondence Address: YARON MAYER, 21 AHAD HAAM ST., JERUSALEM, 92151, IL

(21) Appl. No.: 10/615,981

(22) Filed: Jul. 10, 2003

Related U.S. Application Data
(63) Continuation-in-part of application No. PCT/IL02/00020, filed on Jan. 10, 2002.
(60) Provisional application No. 60/291,161, filed on May 14, 2001.
(60) Provisional application No. 60/305,214, filed on Jul. 10, 2001.
(60) Provisional application No. 60/307,095, filed on Jul. 20, 2001.
(60) Provisional application No. 60/440,000, filed on Jan. 10, 2003.

(30) Foreign Application Priority Data
Jan. 10, 2001 (IL) 140841

(51) Int. Cl. B41F 5/02

(52) U.S. Cl. 101/229

(57) ABSTRACT

Both Laser printers and Inkjet printers have undergone many improvements in the last 10 years—mainly becoming faster and with better resolutions, and with prices going down all he time. However, one of the biggest limitations of all these types of printers has remained the same all the time: They print just on one side of the page. Although some printers on the market have an optional additional unit for mechanically flipping pages over, these units are typically cumbersome, expensive, and require extra space. Also, with mechanical flipping there is a higher chance for various malfunctions. Being able to efficiently print on both sides of the page can have many advantages: Saving paper costs, saving trees, saving office space or home space, being able to double the printing speed, being able to easily print eBooks, and more. The present invention tries to solve the various problems of being able to print simultaneously on both sides of the paper without slowing down the printing process and without having to mechanically flip the pages, so that practically the printing speed is more or less doubled. The solution is in principle similar in both inkjet and laser printers, although there are some variations that stem from the different mechanisms between these two main types of printers. In Both types of printers and in other printers the main principle is using a second printing element simultaneously at the other side of the page, either at exactly the same position on the paper, or with a preferably slight shift between the two positions. The present invention solves all the relevant problems for each type of printer and covers many possible variations, including variations where cheap and efficient automatic folding of papers is used for printing eBooks. It also shows many improvements over other patents that tried to solve the problem without flipping the pages. Another important feature of the patent is a variation where a laser printer is combined for example with inkjet printheads, preferably after the paper exits the fixing elements of the laser—which has a lot of advantages and great price-performance, and also various problems have to be solved in order to enable this, especially if used in combination with simultaneous double-side printing. This way the user can print for example all the black text (and preferably also for example texts that were completely or mostly in a single other color) through the laser unit and any additional needed colors (preferably images, and elements in the text that are in different color) can be added by the inkjet printheads.

### BACKGROUND OF THE INVENTION

1. Field of the Invention

The present invention relates to printers, and more specifically to a printer capable of printing simultaneously on both sides of the page, preferably with an optional addition of a means for automatically printing and binding e-books.

2. Background

The most common printers today are Inkjet printers and Laser printers. Inkjets are based on a moving head with typically 3 colors+black and print by squirting very small droplets of ink on the paper. They are divided into two main types: Those that use a thermal head for pressing the ink droplets, in which the head is typically replaced when the toner is changed, and those that use a piezoelectric head for pressing the droplets (mainly Epson printers), in which the head is typically for the lifetime of the printer. The second type usually allows better speed and better printing quality and also allows more flexibility in choosing various types of inks. Typically there are 4 basic colors—Black, Yellow, Magenta, and Cyan. Laser printers are based on a photo-conductive cylindrical drum which is made electrically charged as marked by the laser and then the toner powder is electrically attracted to the electrically charged points, and is afterwards transferred to the page by giving also a charge to the page, and then the powder is made permanent on the page by a combination of pressure and heat. Typically the drum has a small diameter of 3-4 centimeters and is inside the toner cartridge, which is replaced when the toner powder runs out. Typically the printing process works like a production line in which a line of pixels is drawn by the laser (typically by making the laser go on and off very fast, in correlation with a rotating mirror) or by LEDS (which are lit in the appropriate on/off bit pattern). Then, during the rotation of the drum, this line passes through the toner powder, and eventually it reaches the point where it is coupled to the paper, and afterwards it reaches a place where the drum is cleaned and ready for redrawing. Laser printers are also divided into two main types: Those that use a laser beam deflected by a fast rotating mirror for drawing each pixel line, and those that use instead an array of very small LEDs for drawing each line of pixels. LED printers are somewhat cheaper than ordinary laser printers and have more or less the same quality. An additional advantage is that in laser color printers the LED version is typically able to deal with the 4 basic colors at the same time, so, unlike a normal laser printer, which typically prints in color 3-4 times slower than in black and white, the LED color printer can print in color also at the full speed. An example of such a printer is the new IBM Lexmark 1200N. There are also some color printers based on melting solid bars of wax-like material, which have qualities somewhere in between laser printers and inkjet printers.

Both Laser printers and Inkjet printers have undergone many improvements in the last 10 years—mainly becoming faster and with better resolutions, and with prices going down all he time. However, one of the biggest limitations of all these types of printers has remained the same all the time: They print just on one side of the page. Although some printers, such as some higher-end models of HP laser printers have an optional additional unit for mechanically flipping pages over, these units are typically cumbersome, expensive, and require extra space. Also, with mechanical flipping there is higher chance for various malfunctions. Also, if the flipping is not done each page at a time, any mechanical malfunction of even just one page getting stuck, or feeding for example two pages instead of one, can destroy an entire batch of printing because the pages will be shifted from then on. Being able to efficiently print on both sides of the page can have many advantages: saving paper costs, saving trees, saving office space or home space, being able to double the printing speed, being able to easily print eBooks, and more.

The most relevant previous patents that tried to deal with duplex printing not based on flipping the pages over and feeding them back are: U.S. Pat. No. 5,670,995, issued on Sep. 23, 1997 to Kupcho & Delano, U.S. Pat. No. 4,796,066, issued on Jan. 3, 1989 to Morris & Daniels and later abandoned, U.S. Pat. No. 3,580,670 issued on May 1971 to Bhagat (assigned to Xerox), U.S. Pat. No. 4,410,897 issued on Oct. 18, 1983 to Moriguchi et. al. (assigned to Fuji Xerox Co.), U.S. Pat. No. 6,175,715 issued on Jan. 16, 2001 to Hirao et. al. (assigned to Fujitsu), U.S. Pat. No. 6,032,015, issued on Feb. 29, 2000 to Umeda et. al., and Japanese patent JP2259670 published on Oct. 10, 1990 and assigned to Nec. The Bhagat patent discussed the possibility of using two drums, each on one side of the paper, at a certain displacement from each other, for copying and printing on both sides of the paper, using partial fixing of the toner after each drum, and permanent fixing at the end. However, it didn't deal with many other issues, such as the physical orientation of the drums, avoiding spilling of toner if the drums are not upright, etc. The Moriguchi patent dealt with two-sided thermal printing, but in this case there is no problem of putting one of the two heads for example below the paper. The Japanese patent discussed the possibility of transferring and fixing toner simultaneously on the two sides of a paper passing between two drums facing each other, but was based on giving opposite electrical charges to the two drums, so that the toners on both sides of the paper will attract each other. However, this has a number of disadvantages, and mainly: 1. If the toners from both sides are attracted to each other they can interact and change positions and thus be affected by the other side. 2. In areas where the paper is white on one side and black on the other there would be no 2^{nd} toner to be attracted to. 3. When there is no paper between the two drums there would be an electrical discharge. Also, the drums are shown one below the paper and one above it, which could cause for example problems of toner spilling. The Umeda patent discussed the possibility of printing on both sides by passing the paper between two drums, one below the paper and one above it, where the drums are either facing each other or at a certain displacement from each other, but again based it all on using opposite charges for the two sides of the paper, and also the drums are shown one above the paper and one below and the issue of toner spilling is not addressed. The Kupco & Delano patent dealt with simultaneous duplex printing in Inkjet printers, but was based on securing a sheet of paper in a substantially rigid plane between a first and second pair of rollers and printing on both sides between the two sets of rollers. This solution has two disadvantages: 1. This way the newly printed ink can be smeared upon reaching the frontal set of rollers. 2. This way there has to be a substantial top margin on each page that cannot be printed on since the top of the paper has to be already within the set of frontal rollers before printing can begin. The Morris & Daniels patent deals with double sided printing on printers such as Laser printers (but not limited to lasers) but is based on moving the paper into two consecutive upright printing elements, so that the paper has to make a U-turn around the 2^{nd} printing element and enter the 2^{nd} printing element in a substantially parallel but opposite direction from the direction of entering the first printing element. This also has a number of disadvantages: 1. The paper has to make a long round path, so that it becomes similar to mechanical flipping, and also it becomes difficult to use separate sheets of paper, so the invention is described mainly in relation to a continuous roll of paper. 2. According to this invention for printing only on one side the paper has to be routed differently, which complicates things. 3. According to this invention the 2^{nd} side of each page is always printed only after the first side has already been printed and the page exited from the first printing station and in fact is printed while the 1^{st} part of the next page in being printed, which is cumbersome and unnecessarily lengthens the paper path. There have also been a number of patents for simultaneous duplex printing based on moving conveyor belts, but such solutions are more complex mechanically and require more maintenance and are therefore typically also much more expensive. The Hirao patent is the most sophisticated from the above: It shows two cartridges with a shift in their positions, one above the other, and the paper moves in a substantially vertical direction, and discusses various improvements such as for example flash fixing that does not depend on touching the paper, and the ability to move the paper also backwards for clearing jams. However, as apparent from the drawings and the descriptions there, many aspects of the patent are applicable only to continuous paper, so the problem of stabilization when using normal sheets of paper is not addressed. Also, the fixing elements are used only after the paper has passed both printing drums, so there is no real advantage from having a distance between their positions, and in fact it can be a disadvantage since this just lengthens the time and space that the paper travels with toner on both sides that has not been fixed yet. Also, the fixing is done by two consecutive single-side fixing elements instead of using identical rollers that can fix both sides at the same time at the same position. And also it wastes space in the printer and makes reaching the lower toner cartridge more difficult. Also it is apparent that it is designed to be a high-end expensive printer, using larger drums and other means for higher speeds, etc. On the other hand it does not address the issue of printing with more than one color.

### SUMMARY OF THE INVENTION

The present invention tries to solve the problems of being able to print simultaneously on both sides of the paper without slowing down the printing process and without having to mechanically flip the pages, so that practically the printing speed is more or less doubled, and without the problems and limitations of the above solutions. A further objective of the present invention is to provide a cheap and effective low-end double-side printer, and especially duplex version inkjet and laser printers, which are the most common printers in homes and offices. The features of the present invention are designed so that preferably these printers will cost only a little more than the equivalent single side printers, such as for example about 10-30% more. The solution is in principle similar in both inkjet and laser printers, although there are some variations that stem from the different mechanisms between these two main types of printers. In Both types of printers and in other printers the main principle is using a second printing element simultaneously at the other side of the page, either at exactly the same position on the paper, or with a preferably slight shift between the two positions. And, as shown in various examples below, the drums and/or cartridges and/or printing heads and/or ink containers may be for example on two sides of a more or less vertically moving paper, or at other orientations and/or angles and/or positions, for example in relation to the cartridges or to the paper or to gravity or to the other parts of the printer, and various angles for the input and output trays and for the paper path near the printing elements may be used. This means of course that the paper can move in various directions and also the path between the drums (or printing heads, respectively) is not necessarily in a straight line—for example a preferably small bend or twist in the paper path may be used in some variations of the orientations where there is a shift between the printing positions, for example in order to enlarge the area of contact with each drum.

In Inkjet printers the biggest problem when trying to print on both sides of the paper at the same time is avoiding smearing the ink droplets before they had a chance to dry sufficiently. There are a number of solutions to this problem:

1. Make both printing heads move together in complete coordination on both sides of the paper so that each head gives the counter-force to the other. The only disadvantage is that this way each printing head always has to wait for the other head even if there are for example white spaces or empty lines that it could normally skip, so that such skipping occurs only when there are empty spaces on both sides of the page at the same area. Another problem is that, in order to avoid corrosion, the printing head in Inkjets typically does not touch the paper directly but squirts the paint from a small distance, such as for example half a millimeter, from the paper. Therefore, in order to keep the printed area in position, preferably the printing heads or their surrounding areas have at least one part that touches the paper—preferably shifted a little towards the direction from which the paper is coming in (i.e. upstream of the position where the ink is squirted), so that no smearing can occur. This touching part is preferably strong enough so as not to corrode after prolonged use and yet gentle enough so as not to damage the paper, such as, for example, a strong plastic or Teflon or silicon or glass or some diamond coated element with preferably round edges. Another variation is to use for example one or more wheels on both sides of the paper in this area, which roll in the direction that the 2 heads are moving back and forth, but then the wheels have to be slightly removed from the paper whenever the paper itself needs to advance. Another variation is to use instead of wheels one or more balls on each side, so that the balls roll in one direction when the heads are moving and in another direction when the paper is moving. Preferably, the paper is also held mechanically for example by preferably small wheels or rollers at its 2 sides also after passing the printing heads (right and left, since at least a few millimeters are always kept free of paint as margins). Another problem is how to make the two heads move together. One possible solution would be to link them from one or both of the sides, but that would mean having to make the printer at least twice wider than the paper. Another solution is to use for example a stationary frame just a little wider than the width of the paper and move the two heads together each time right or left by one or more engine that pulls one or more flexible wire or string (connected to both of the heads and moving around the frame for example by means of some wheels on the turning points of the frame). Another variation is to use a separate engine for each head, so that coordination between the two engines is achieved by electrical means. Another possible variation is that the heads can move sideways independently, as explained also for example in the reference to FIG. 1. Another possible variation is that the heads on the two sides of the paper move in opposite directions sideways (for example by the use of two separate engines or by moving a band that connects them around the paper or by relay wheels, but separate engines are preferable due to less wear problems), which has the further advantage that while printing the paper is not wet by ink droplets at the same time on the same position from both sides of the paper. Another variation, as mentioned above, is a preferably slight shift in the printing position between the two heads, which also has the above advantage. Another possible variation is that instead or in addition to balls or wheels that are a little upstream of the position where the ink itself is squirted on the paper, there are additional wheels or balls that are always at the side of the squirting position (column-wise) but at the same position line-wise. However, in this variation in order to avoid smearing of the newly printed ink, there are preferably two sets of balls or wheels, one on each side of the printhead, so that when the printhead is moving to the right the left set is automatically lifted so that it does not touch the paper and only the right set touches the paper so that it always touches the paper at a point that has not been painted yet, and when the head moves left the right set is automatically lifted away from the paper and only the left set touches the paper. This can be used in combination with any of the other variations, for example when both printheads are moving together at the same position all the time, or when their side movements are in opposite directions, or when their side movements are independent of each other, however it makes more sense to use it in the variation where both heads are moving together, since otherwise there is no direct contra to the side wheels or balls. Other variations and combinations of these solutions are also possible. Each head preferably comes with its own set of color containers and parts that deal with each color. Another possible variation is to use more than two heads, for example sideways or in the direction of the movement of the paper, for increasing the speed of the printing even further.

2. Another variation (shown in FIG. 1) is similar to solution number 1, except that, instead or in addition to the above, the paper is held in position preferably by two or more stationary elongated rollers on both sides of the paper, so that the paper reaches them just before it reaches the printing heads and preferably as close at possible to the heads, so that the part of paper that enters the rollers is always not painted yet, and the rollers don't move with the head and turn only when the paper is being fed in. Preferably, there are a number of rollers along the way, and the rollers closer to the heads pull stronger in order to stretch the paper and thus make it more stable. Of course, various combinations of versions 1 and 2 can also exist, for example by using the stationary rollers and also balls that move with the heads, for maximum stability of the paper at the area being printed, and preferably this is used together with stabilizing side devices such as for example those described in FIGS. 1a-c. Another possible variation is that the rollers and/or the head on one side are shifted preferably slightly from the position of the head and rollers of the other side, as shown in FIG. 2.

3. A third variation is to get rid altogether of the moving heads and use instead elongated heads that print an entire horizontal line or strip or lines on the page at each step. Since the elongated head does not have to move sideways back and forth, it (or at least part of it) can preferably be placed more close to the paper and thus help stabilize the paper, and of course this has the further advantage that faster speeds can be reached and there are less mechanical problems due to fewer moving parts. This is shown in more detail in FIGS. 3a-b. For printing in colors, preferably either the head can at each step insert color from any of 4 basic elongated color containers, or for example on each side of the paper one elongated head is internally divided into a number of elongated parts, each connected to one color container, or there are 4 separate elongated heads near each other, so that at the same time each head deals with one color and so at each step at least 4 different pixel-lines are being dealt with at the same time, but each of these lines is consecutively treated in turns by the appropriate color-head which adds to it whatever it needs. Preferably, slightly before reaching the elongated printing heads, the paper passes through one or more stationary elongated rollers on both sides of the paper, like in solution number 2. Another possible variation is to use for example shorter moving elongated heads which have to move only part of the way, such as for example heads that are half the width of the paper. This is less fast than stationary heads but saves costs and is still faster than the current state of the art heads. Both moving and stationary elongated heads have an additional advantage over the state of the art heads: Since normal color heads are sideways to each other, their speed is limited also by the fact that each color head prints on top of those next to it as they move sideways, so their speed is limited by the need to let the ink droplets dry sufficiently, whereas color heads that are spaced in the direction of the movement of the paper instead of sideways do not have this problem. Another possible variation is just to use heads spread like this (in the direction of the movement of the paper), instead of sideways without necessarily making them longer, which further saves costs but still has the above advantage over the state of the art sideways-spaced color heads and thus can enable the heads and the paper to move faster. Another possible variation is that in all of the above variations preferably there is also some additional gap between each two adjacent color heads (such as for example a few millimeters or even a few centimeters) in order to further give the ink a chance to dry a little before the paper enters the position of the next printing head. However, especially if the gap is bigger then a few millimeters, preferably the page is limited as tightly as possible sideways, since otherwise sideways fluctuations during the movement of the paper can cause mismatching in the positions of colors that should be on the same spots. If the heads are moving heads then either just one rod (on each side of the paper) is used for all the heads of that side to move over sideways, or more than one rod is used, for example if the gaps between the heads are bigger. Another possible advantage of the above variations is better resolution since the droplets of each color can dry faster without spreading too much near each pixel when they hit a drier paper than if they hit a paper that is still wet from another color droplet which was sprayed a split second earlier on the same position. In addition this can improve the resolution since preferably each elongated separate color head can squirt droplets more closely to each other. In all of these variations preferably the paper is also heated in advance and/or at the positions of the printing heads or for example by the last set of rollers before the paper reaches the heads in order to even further increase the speed of drying and thus preferably enable even higher speeds and better resolutions. Of course, in all of these variations the software or firmware has to take into consideration the different positions of the color heads for printing the page correctly. All of these improvements, including moving and stationary elongated heads can also be used for faster one-sided printing, independently of any other features of this invention, and can be also used similarly for example in one-sided or two-sided solid ink printers, which can make them faster both with or without intermediary drums for increasing the speed. Another variation, as mentioned above, is a preferably slight shift in the printing positions between the groups of heads of the two sides of the paper, which has the advantage of avoiding wetting the paper with ink droplets at the same time on the same place. Of course, various combinations of the above variations can also be used. Although, for example U.S. Pat. No. 6,234,605 issued on May 22, 2001 to Hilton (assigned to Xerox) deals with a pagewidth print head for inkjet printers, the separate colors elements there are rotating on the same elongated head.

4. Another improvement, which can be used in combination with any of the previous solutions, is using a catalyst for speeding up the drying process of the ink droplets. This can be done for example by putting at the head position or a short distance in front of it (downstream) an elongated element that heats the recently painted strip of paper, or moves air near it, or covers it with a preferably thin layer of wax or transparent plastic, so the image will also be more durable and resistant to water. Another possible variation is for example to pre-heat the paper, or heat it just before in reaches the printing heads, for example by using the last set of rollers before the heads to also heat the paper, which might be even more preferable since this way the droplets already reach a hot paper so they can dry faster without having a chance to spread first, and also this way the heating element itself cannot cause smearing because it is done before the droplets reach the paper. Also, preferably, the ink is for example alcohol-based instead of water-based, so that its drying speed is inherently faster than water, and therefore the ink is inherently also less destructible by water after the paper has been printed upon. Of course, various combinations of the above variations are also possible.

In both ordinary laser printers and LED printers in order to print on both sides at the same time the paper is preferably rolled between two drums, so the paper is also automatically stabilized. Another possible variation is to add also for example rollers that stress the paper before reaching the printing position, such as for example those described in clause 2 above regarding inkjet printers and/or any of the side devices discussed in FIGS. 1a-c, which enables using less pressure between the two drums, however these additions might be used also if the drums use sufficient pressure. In both types of Laser printers there is a similar problem of possible smearing of the image if the toner dust is sprayed on the paper on both sides at the same time, and the problem is even more complicated by two additional elements: a. Arrangements are preferably made for the laser or LED light to reach the drums at the same time on both sides of the paper, b. The opposite electrical charges used to attract the toner first to the drum and then to the paper have to be arranged so that the charges on both sides of the paper don't interfere with each other. In order to solve the smearing problem, preferably the element that fixes the toner powder to the paper by heat and pressure is located as close as possible after the 2 drums, so that as soon as the newly painted strip of paper exits from the drums, the toner on both sides of the strip is fixed, so that it won't have a chance of getting smeared before getting fixed. Preferably, the fixing is done by rolling the paper between two preferably identical heated rollers that also apply the pressure on both sides of the paper. Another possible variation is for example using just one heated roller with a preferably flexible counter-roller (such as for example heat resistant plastic or rubber, preferably with the same diameter as the heated roller, in order not to stress the paper) on the other side of the paper, so that the heat and pressure from one side is enough to fix the toner also on the other side of the paper, or using for example two sets like this, one after the other, so that the first fixes better one side of the paper and the other fixes better the other side of the paper, however a fixing element that fixes both sides at the same time is more preferable. Another possible variation is to use other methods for fixing the toners on both sides simultaneously, such as for example flash fixing at both sides at the same time and position. In order to solve the charge interference problem, preferably the polarities of the charges are kept normal, so that for example the toner powder on both sides is negatively charged, and the paper is positively charged. However, to avoid interaction (for example repulsion by the toner powders on both sides), preferably the negative charges of the toner powder are relatively weak and the positive charge of the paper is made stronger, for example by using higher voltage. (Of course, the charges can also be reversed, preferably in a different embodiment, so that for example the paper can be negative and the powder positive, etc.). Preferably the paper is finally discharged upon or before exiting to the output tray, so that the user does not have unpleasant effects due to remaining static electricity. Another possible variation is to use, preferably in addition to the above, also paper (or other printing material) with a different dielectric coefficient (for example higher or lower than normal paper). In order to enable the light from the moving laser beam or the LED array to reach both drums at the same time, in one possible variation preferably there are two laser sources or two LED arrays, respectively, and they can reach the appropriate drum from any convenient angle at the appropriate side of the paper. Another preferable variation is using just one laser source, and then splitting it optically into two beams, one for each side of the paper, so that preferably each of the 2 new beams is diverted by its own rotating mirror or prism and is separately modulated in on/off fluctuations (for example by another rotating or moving element, or by LCD, or by Mach-Zehnder Modulator, or lithium niobate modulator or other fast methods such as those used with optic fibers communications, etc.). Another possible variation is using, again, just one laser source, and using an optical conductor or conductors, such as for example a mirror(s) and/or prism(s) and/or optic fiber(s), to transfer the light to the other side of the paper, so that preferably part of the rotation of the mirror or mirrors (or prism or prisms) runs the laser light over the appropriate pixel-line on the drum on one side of the paper, and another set of angles of rotation runs the light into the optical relay system which correspondingly diverts the laser light to the appropriate position in the pixel-line on the other drum on the other side of the paper. Since the rotation of the mirrors and the on/off pulsing of the laser are very fast, this should cause no delay in the actual printing speed. These two variations can save costs. If color printing is used, these or similar methods can be used also for splitting one or more laser sources into up to 4 beams per side. The toner cartridge itself is either a special double-drum cartridge made for the double-sided printer, an example of which is shown in FIGS. 5a-c (which has the advantage that the toner can be easily balanced so that it doesn't run out on one side, for example if the user prefers to print some of the times just on one side), or the printer is arranged so that two standard cartridges (for example a little tilted towards each other so that their drums can touch each other) (or more preferably 2 separate cartridges optimized for this by having their drums shifted to the facing corners like mirror images, an example of which is shown in FIG. 4), preferably facing each other, can be used. Another possible variation is creating some shift between the points where the two drums hit the paper, so that for example one of the drums touches the paper a few centimeters before the other, preferably each drum pressing against some counter-roller on the other side of the paper. Another possible variation of this variation is to add also between the positions of the two drums an additional fixing element such as for example a set of rollers that fix the powder by heat and pressure, so that the powder on each pixel-line of the 1^{st} side of the paper is already set when the corresponding pixel-line on the other side of the paper enters the second drum, as shown in FIG. 4b.

This is also another way to help for example to solve the problem of preventing the toner powders from both sides of the paper from repelling each other. Also, the stronger electrical charge of the paper compared to the toners can be used of course also in this variation. If this fixing is done between the two positions, preferably this is normal fixing and not partial fixing. Another possible variation is that preferably during or after this fixing the toner on the paper is also discharged from its electrical charge, for example by the fixing roller itself or by a metal part after it. Another possible variation is to have the two cartridges actually touch each other, so that the distance between them is minimal. However, the variations without the shift in position have, apart from more mechanical simplicity and elegance, the further advantages that maintenance such as for example reaching the cartridges positions for clearing paper jams or changing cartridges should be easier, since both cartridges are on the same level, and also the height of the printer can therefore be smaller, thus keeping the printer more compact. Another advantage is that passing between the two drums further helps stabilize the paper. Another advantage is that for example if it is a color laser printer, preferably more than one cartridge is used on each side, or a number of double-drum cartridges are used, so the total height of the printer still remains the same as with a single-side laser printer, whereas in the version with the shifted positions the printer would become much higher and maintenance even much more difficult. Another possible variation is for example to pre-heat the paper already upon entering the drums or for example to use toner powder that contains also some adhesive elements, such as for example a preferably small percent of glue, so that it sticks better even before fixing, but preferably this additional adhesive does not change the behavior of the powder elements towards each other. Similar solutions and variations can preferably be used also for example in printers where the drums are not part of the toner cartridge and/or are replaced separately from the toner. For color laser (or LED) printing, similar variations can also be used by either using just one drum for each side so that only the toner is separated to 4 different containers, or using a separate drum for each color, as in the Lexmark 1200N, which means in this case for example 8 drums (in either 8 cartridges or 4 double-drum cartridges). In these color variations preferably the fixing is done after the paper has gone through all the drums on both sides, in order to improve the mixing of colors for each pixel, however it is also possible to use full or partial fixing on the way. Other variations & combinations are also possible. The above variations, and especially those without a shift between the positions of the cartridges, can be very cheap because no additional laser is needed, almost no additional mechanics is needed, and the user simply buys two toner cartridges (or a double-drum toner cartridge) at the same time, which preferably lasts for twice the number of pages of a single cartridge.

Another possible variation, preferably in another embodiment, is to use some combination of preferably a laser (or LED) printer and inkjet printer, preferably with the laser before the inkjet, so that for example preferably after the paper exits the position of the fixing elements that set the toner, the paper moves through a position of inkjet printing heads, which can add color wherever needed. This has many advantages and is much cheaper than using for example an ink jet (in terms of consumables) or buying for example both an inkjet and a laser printer, since typically most printing is in black and only a small percent is in color, so this way the user gets a fast and cheap black printing (in terms of consumables), with laser quality and laser speed, and when color is needed it is added by the inkjet printing heads. It is also cheaper than buying a laser color printer and a solid ink printer since the laser printer has already the input and output trays and all the mechanics for moving the paper, so the cost of adding the inkjet printing heads is just a fraction of a cost of an ink-jet printer, which is very cheap anyway, so the laser with the additional inkjet printing heads should cost only a little more than a laser printer without it. It also saves space compared to two printers, since the addition of inkjet printing heads on the paper path should only increase the laser printer size by a small factor. This has the further advantage that since the paper is still hot at this stage the ink droplets will also dry faster and thus avoid smearing and thus possibly also enable faster inkjet printing and/or improve the resolution. The general arrangement of this and more detailed explanations are shown in the reference to FIGS. 4e-f. However, this combination of inkjet and laser printer can be used also independently of any other features of this invention, such as for example on single-side printers and with any type or variation of inkjet printing known in the art. A similar combination can be done for example between the laser printer and a solid ink unit (of the type with or without drums) or other types of printing that can add color, although it is cheaper do to it with an inkjet unit, but this variation might be used for example for professional printing of books, where quality is more important. Another possible variation is for example the color printing first and the laser later, but this is more problematic, since for example the ink might enter the laser drums while still not dry enough and thus smear, especially for example if the paper is simultaneously printed on both sides. Another possible improvement is for example adding a 4^{th} basic color, such as for example Green (or even more than one additional basic color) in order to improve the percent of possible colors that are covered, since as has been shown in PCT applications WO0195544 and WO02101644 by Genoa Color Technologies, for example the prior art RGB's ability to produce all the possible colors is only a myth, and in reality, although millions of color combinations can be displayed by the RGB method, they cover only combinations within a smaller triangle that represent only about 55% of the real triangle that represents the true number of color combinations that the human eye can see. However, the above applications ignore the possibility that a similar problem exists also when printing pages on a conventional color printer that uses only 3 primary colors apart from black, due to the fact that the inks used do not have ideal light absorption and reflection characteristics. In fact the problem in printers is probably even much bigger since typically there are only about 5,000-6,000 printable colors compared to about 16 million colors that can be displayed by a typical monitor. This additional primary color or colors is preferably added in the laser-inkjet or laser-solid-ink hybrid variations or for example in normal (preferably double sided) Inkjet printers or solid ink printers (since adding for example a 5^{th} toner cartridge to a color laser printer would make it even more expensive and cumbersome and large), and preferably such additional basic color (or colors) is added in the variations that use elongated page-width printheads where the separate color heads are preferably at some distance from each other, since these variations allow maximum independence between the colors and flexibility. Of course, like other features in this invention, this can be used also independently of any other features of this invention.

In solid-ink color printers (which are typically based on solid ink wax-like bars, and are also known as solid wax, phase change, or wax jet printers), the solution is very similar to that of ink-jet printers, since in practice the heads work like ink-jet by liquefying the ink and spraying it through tiny nozzles onto the paper's surface. The main difference is that the dot pattern of the ink droplets typically cools and resolidifies before they are absorbed by the paper, and the paper is then fed through a pair of rollers that cold-fuse the image. This makes it even easier to use the simultaneous both-sides printing here, because this pair of rollers which the paper passes through after the printing heads can further help stabilize the paper, and can easily be used to fuse both sides at the same time. Like with the solution for ink-jet printers, as explained in FIGS. 1 & 3a-b, various angles for the input and output trays and for the paper path near the heads may be used and also the printing heads and/or the ink bars may be for example on both sides of a relatively vertically moving paper, or also at other orientations and/or angles and/or positions (in relation to the paper path or to gravity or to other parts of the printer) and/or shapes. Another advantage is that with solid bars of ink, it can be even easier to implement a version where the printing heads of the other side are below the paper (for example if the paper is moving in a more or less horizontal direction), since there are less problems of gravity. Another possible variation is to use two separate pairs of these rollers, which can be useful for example in the variation with a preferably slight shift between the printing positions on the two sides of the paper (so that for example one set of the rollers is between the two printing positions). However, there is another variation of solid ink printing, used by Xerox's Tektronix Phaser printers, which is based on spraying the ink on a drum and then transferring it from the drum to the paper, in a way similar to laser printers. This enables speeding-up the printing process to laser-printer-like speeds, such as for example 14 pages per minute. This has an advantage over color laser printers because all 4 basic colors can be easily used on the same drum instead of typically using 4 separate drums. In this case the solution for the simultaneous both-side printing is similar to the solution for Laser and LED printers, and preferably a separate set of solid inks and printing heads is used with each drum, as shown for example in FIG. 4d. So, again, the drums on both sides are either at the same position on both sides of the paper, or with a preferably slight shift between them, and, again, like the explanation in FIG. 4, the drums can be for example on both sides of a relatively vertically moving paper, but also various other angles for the input and output trays and for the paper path near the drums may also be used and the drums may be also at other positions or orientations or angles (in relation to the paper or to the gravity or to other parts of the printer). In this case there is no problem of spilling toner, so it is also possible to use also variations where one of the drums is below the paper.

Another variation or possible improvement, preferably in another embodiment, in preferably double-sided Inkjet, Laser, solid-ink printers and other printers, is adding an appropriate mechanism so that the printer can act also as a printer for e-books. This can be useful for example for printing eBooks downloaded from the Internet, or for example for people who want to publish books in small batches with low costs. This can be used also for example in single-side printers, independently of other features of this invention, but it is much more appropriate for double-side printing. In order to accomplish this there are, again, a number of solutions, but the main two variations or embodiments are:

1. The printer cuts the pages to the appropriate number of parts, or uses paper prepared in advance for the proper size (from one or more input trays or for example from an input tray that can be adjusted to feeding-in various sizes of papers.), and glues all the pages together at the back of the book. Preferably, the printer either cuts the pages into smaller parts before printing on them, or uses for example any of the methods described in FIG. 7 for first folding and then cutting at the fold, in order to avoid mixing up of the parts after they are cut.

2. The printer folds together groups of pages (such as, for example, 6 or 12 pages, or any other convenient number of pages), and preferably the number of pages in each group can either be determined by the user or automatically calculated by software, or both. Each group of pages is then fixed together, preferably by mechanical means such as for example staples, and then the groups are preferably glued together at the back of the book. If more than 4 pages (2 per side) per sheet of paper are used, then preferably the printer is also able to automatically cut the edges at the folds where needed.

In all of these types of solutions, the printer is preferably able by appropriate software (running either in the printer or in the computer or both) to keep in memory the required group of pages and plan the printing so that the printed faces will fit the planned configuration, and rotate the printing by 90 degrees for example when needed. This means of course that in all the embodiments where there is a shift in the position of the printing elements between the two sides of the paper, this is also taken into account so that the printing on both sides appears properly coordinated in its position, and also the positions of the printing elements are of course taken into account when there are a number of printing elements along the way for color printing. Preferably, the printer is able to print either just two pages on each sheet of paper (one on each side of the paper), or 4 pages (2 on each side), or 8 pages (4 on each sided), etc. However, it is more efficient to allow only up to 4 pages per sheet of paper, so that additional divisions are preferably allowed only by cutting the paper in advance. This way the printer can be used, for example, either for printing e-books, or for normal printing, or for printing for example Internet pages as either simply 1 page (for example by telling the printer by software and/or through the control panel to ignore the back of the paper and print only on the front side) or 2-sided pages, or as 4 pages per standard sheet of paper (preferably by rotating the image 90 degrees and proportionally reducing the images and the font sizes), so any Internet site can be automatically printed like this without any special designing needed. Of course if the user prints only a small number of pages for example with 4 pages on each paper (2 pages on each side) then no special folding is needed and the user can for example simply remove the printed papers and staple them and the middle of the papers and then fold them at the middle.

In Laser printers (and similarly in solid ink printers with drums), when printing only on one side, preferably the cartridge and/or drum in the unused side is automatically moved slightly away from the paper so that it doesn't have to touch it, which saves unnecessary wear of the unused drum and unnecessary risk of spilling toner. In this case, if the drums are facing each other without a shift in the printing position, preferably when the drum in the unused side is automatically moved slightly away, another counter-roller is pushed into position instead. This counter-roller can be for example part of the printer or part of the cartridge. (Another possible variation is to use for example a low-friction surface instead of the roller, such as for example a Teflon-covered sponge or rubber, which is preferably part of the cartridge, so that it is replaced when the cartridge is replaced). If it is for example a color-laser printer then preferably all the cartridges and/or drums on the unused side are slightly moved similarly. Also, the printer can either be made to use a roll of consecutive paper or ordinary sheets or both (preferably in different embodiments), but using ordinary sheets is more preferable since they are much more common. Various methods of implementing these solutions are shown in the detailed description.

### BRIEF DESCRIPTION OF THE DRAWINGS

FIG. 1 is an illustration of a side-view cross-section of a preferable way that the two printing heads and rollers in the inkjet printer are arranged so that the heads handle the paper very close to the rollers on both sides of the paper.

FIGS. 1a-c show a few preferable variations of possible side devices to help stabilize the paper.

FIG. 1d shows a side-view cross-section of a preferable variation in which there are two L-shaped ink containers on the two sides of the paper, and the paper is moving between them for example from the top down or from the bottom upwards.

FIG. 2 is similar to FIG. 1, except that there is a slight shift in the positions of the rollers and/or the head between the 2 sides of the paper.

FIGS. 3a-b show a side view and a top view of a preferable version where the printing heads are elongated and non-moving.

FIG. 3c shows another possible variation, in which each of the elongated heads (31a) is broken into a number of smaller elongated heads.

FIG. 3d shows a side-view cross-section of a preferable variation of using “L” shaped ink containers with the elongated printing heads.

FIG. 3e shows a top view of a preferable version where the printing heads are of normal size or elongated but not full width and are moving sideways.

FIG. 4 is an illustration of a side-view cross-section of a preferable way the two drums in the laser printer are facing each other in two cartridges that are close to each other and the paper passes between them.

FIG. 4b is an illustration of a side-view cross-section of another variation in which the two drums are facing each other in two cartridges with a certain shift in their position.

FIG. 4c is another example of a side-view cross-section of a variation in which the two drums in the laser printer are less facing each other in the two cartridges with a certain shift in their position and the paper passes between them with a preferably slight bending between them.

FIG. 4d is an illustration of a preferable way that the drums are facing each other in solid ink printers that use drums, and preferably a separate set of solid inks and printing heads is used with each drum.

FIGS. 4e-f shows a preferable variation in which preferably after exiting the fixing elements of the laser, the page reaches Inkjet printing heads or for example solid ink printing heads, that can add color where needed.

FIGS. 5a-c show a side-view, 3-d view, and bottom-view, respectively, of a preferable version where a single cartridge with two drums is used.

FIG. 6 is an illustration of a preferable way that a bunch of papers can be glued together at one of their edges.

FIGS. 7a-f are illustrations of a preferable way that a group of printed papers can be folded together at the middle, in order to be either cut at the fold or stitched at the fold.

FIGS. 8 & 8b are illustrations of another preferable way that a group of printed papers can be folded together at the middle.

### IMPORTANT CLARIFICATION AND GLOSSARY

All these drawings are just exemplary drawings. They should not be interpreted as literal positioning, shapes, angles, or sizes of the various elements. Throughout the patent, including the claims, LED printers are defined as a sub-variation of laser printers, so whenever Laser printers are mentioned, it applies also to LED printers (except when referring to the laser beam). Throughout the patent, including the claims, bubble jet printers are defined as a sub-variation of inkjet printers, so whenever inkjet printers are mentioned, it applies also to bubble jet printers, or any other variation of Inkjet printers. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Eventhough the invention has been described mainly in regard to inkjet, laser and solid-ink printers, it can be similarly applied to other kinds of printers that exists today or that will exist in the future, or other variations of the above printers, or for example Ink Jets or Solid Ink printers with conveyor belts that might exist in the future. Of course, this means that these printing principles can be applied also for example in Fax machines and/or photo-copiers and/or for example machines that combine a printer with a photocopier and/or Fax, etc., and/or any other device that contains printing elements. (Of course, if it is for example within a Fax or a photocopier then preferably there are also color scanner elements and/or duplex scanning elements accordingly). Also, eventhough the invention has been described mainly in reference to paper, it can be used also for printing on other materials, such as for example plastic sheets, or for example for printing on chemical materials such as for example Polaroid films (which can be used in laser-like printers for printing very fast high quality images by applying the light directly to the film). So throughout the invention, including the claims, “paper” means either paper, or any other sheet of thin material that can be printed upon. In all the places where we say that the drums may be also at other orientations and/or angles and/or positions, it means for example in relation to the cartridges or to the paper or to gravity or to the other parts of the printer. In all the places where we say that the heads may be also at other orientations and/or angles and/or positions, it means for example in relation to the ink containers or to the paper or to gravity or to the other parts of the printer. This means of course that the paper path between the drums (or printing heads, respectively) is not necessarily in a more or less straight line—for example a preferably small bend or twist in the paper path may be used in some orientations.

### DETAILED DESCRIPTION OF THE PREFERRED EMBODIMENTS

All of descriptions in this and other sections are intended to be illustrative examples and not limiting.

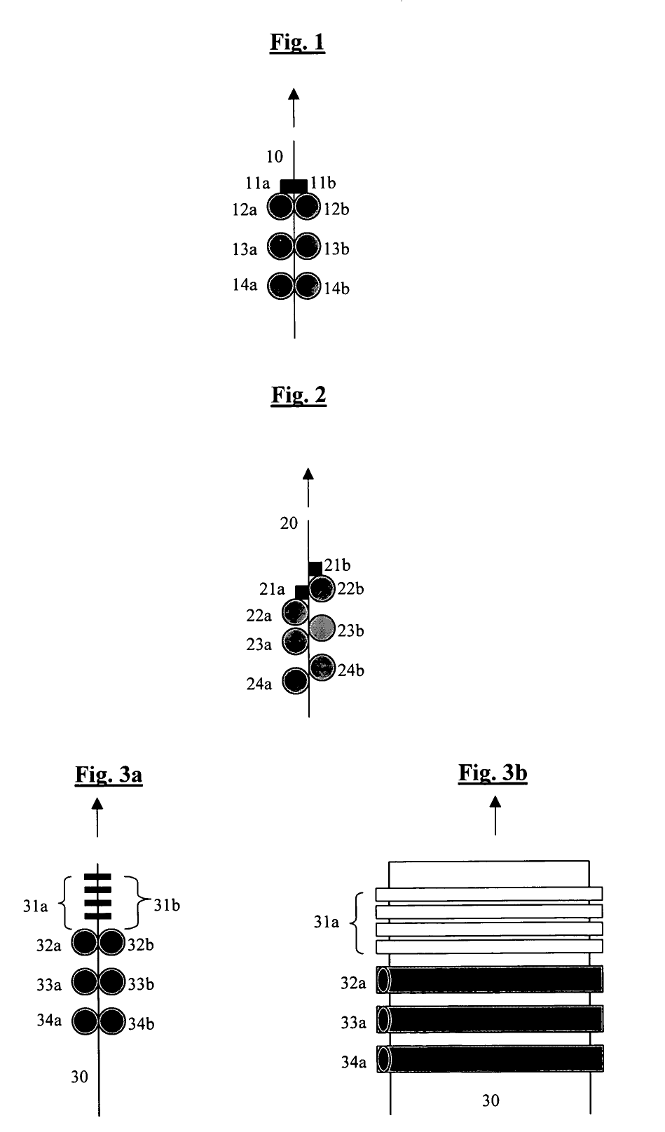

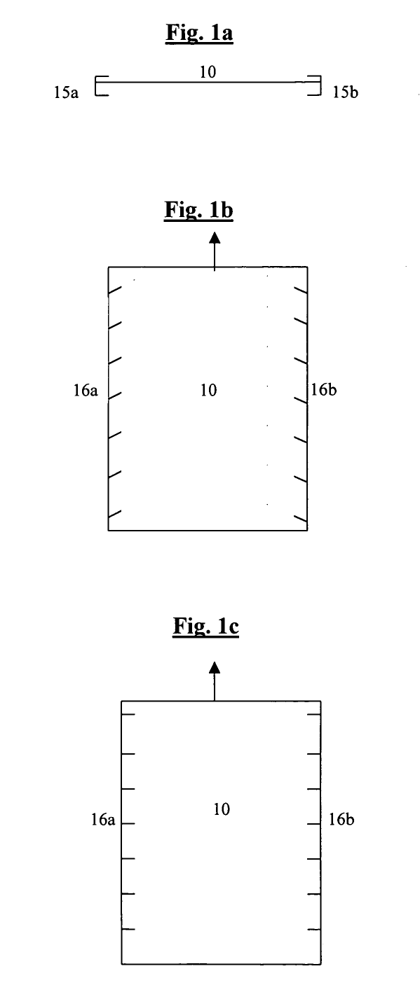

Referring to FIG. 1, we show an illustration of a side-view cross-section of a preferable way that the two printing heads (11a & 11b) and rollers (12a-12b) in the inkjet printer are arranged so that the heads handle the paper (10) very close the rollers on both sides of the paper. The arrow on top shows the direction of the advancement of the paper. This way, the heads always deal with the paper after it exits the nearest rollers, so no smearing can occur. Another advantage is that this way the heads are able to print OK right from the beginning of the paper, since it does not depend on the paper entering an additional set of rollers on the other side of the paper path. If one head is above the paper and the other head below the paper, then preferably the head below the paper uses for example air pressure and/or one or more springs and/or the capillary forces in order to move the ink in its ink containers towards the printing element of the head, since it can't rely on gravity for this. Another possible variation is for example that the two heads are on the two sides of the paper, and the paper moves between them for example from the top down or from the bottom upwards. In this case the ink containers can be for example in an “L” shape for the left head and opposite “L” shape for the right head so that the heads are at the horizontal ends of the containers and face each other, and the vertical parts can take advantage of normal gravity to move the ink towards the printing elements of the heads, as shown in FIG. 1d. Whenever there is no paper between the heads, preferably some element, such as for example plastic or rubber or sponge is entered between them in order to clean them and keep them sealed so that they don't become dry. Of course, the input and output trays preferably can still be horizontally oriented. However various other angles for the input and output trays and for the paper path near the heads may also be used, and also the heads and/or the ink containers may be also at other orientations and/or angles and/or positions and/or shapes. Each of the two rollers (12a & 12b) can either be a single roller or composed of a number of separate rollers sideways. The heads (11a & 11b) can (preferably in different embodiments) either move without touching the paper at all, or also use side-way rollers or, preferably, balls that move together with them (which has advantages as explained in solution number 1 in the summary). If the heads move without touching the paper at all, then they can also be allowed to move sideways (right and left on the paper) independently from each other, however this might make the area of printing slightly less stable, and also it doesn't matter much anyway, because even if the heads can move sideways independently, each still has to wait for the other to finish before the page can be actually allowed to advance to the next step. However, it is more preferable that the heads move independently or move in opposite directions since this way the ink drops on each side don't hit a paper that is wet from drops on the other side at the same time and place, and since preferably the heads don't touch the paper anyway to avoid wear, preferably they have no effect on the stability and preferably other means are used for stabilizing the paper, as explained in the summary and below. Another possible variation is adding additional rollers along the way (such as for example 13a-b and 14a-b) in order to make the paper even more stable. With the rollers closer to the heads preferably pulling stronger. Preferably, the paper is also held mechanically for example by wheels or rollers at its 2 sides also after passing the printing heads (right and left, since at least a few millimeters are always kept free of paint as margins). Preferably, the paper is also held in position on the sides by going through a double-sided long track on the right and on the left of the paper, preferably with the width of at least a few millimeters in the left and right margin areas, as shown in FIG. 1a. Another variation is that on both sides of the paper (in addition or instead of these 2 double sided tracks, however if it is instead of the tracks then preferably some other border is used on both sides to prevent the paper from running away to the sides), there are preferably small pairs of wheels in the margin area which are preferably slightly tilted, so that they pull the paper both forward and to the sides at the same time, which helps stabilize the paper even further, as shown in FIG. 1b. Another variation is that these wheels move straight forwards but have a spiral shape engraved on them, for example made of rubber, so that as they turn each wheel also pulls the paper to the external side, as shown in FIG. 1c. Another variation is using strong static electricity in order to help stabilize the paper, preferably by putting the paper between two or more nearby plates that are also charged similarly (and preferably with appropriate slits in the plates for the various rollers or wheels). These side tracks and/or wheels and/or static electricity with plates can be used either throughout the length of the paper or just at a smaller area, preferably for example near the pixel-lines of the printing heads or before them—where the paper passes after it was printed on by the heads. Of course, various combinations of these variations are also possible. If continuous rolled paper is used instead of ordinary separate sheets of paper (preferably in different embodiments), then stabilizing the paper becomes even more easy because the paper can be continuously held also after it exits the printing area.

Referring to FIGS. 1a-c we show a few preferable variations of possible side devices to help stabilize the paper. FIG. 1a shows in a cross-section looking from the bottom or top of the sheet of paper (10) the long double-sided tracks (15a & 15b) at the right and the left sides of the paper, preferably extending a few millimeters on the right and left margin areas. These tracks are preferably relatively closer to the paper than the drawing shows. FIG. 1b shows the paper (10) in a view from either the front or the back side of the paper with preferably slightly tilted sets of wheels (16a & 16b) at the right and left, in the margin areas. Similar matching wheels preferably exist also on the other side of the paper. (Preferably the angle of deviation from the normal position of straight wheels can be for example any small angle preferably below 45 degrees, and also some variations in angles between the various pairs of wheels are also possible). Many angles can be used, including for example the normal non-tilted orientation, so that for example some of the wheels may be tilted and some straight. Preferably, each set of wheels pulls a little stronger than the set of wheels that are positioned after it (in other words, the wheels that are in the upper side of the drawing are preferably stronger than the wheels that are lower in the drawing). Many variations are possible in the number of wheels and distances between them. In FIG. 1c these wheels (16a & 16b) move straight forwards in the direction of the movement of the paper but have a spiral shape engraved on them (like a screw), for example made of rubber, so that as they turn each wheel also pulls the paper to the external side. These tracks and/or wheels at the sides can either be spread all along the length of the paper or just at a smaller area, preferably for example near the pixel-lines of the printing heads or downstream from them—where the paper passes after it was printed on by the heads. Of course, various combinations of the above variations are also possible, such as for example using both tilting and screw-like patterns on the wheels.

Referring to FIG. 1d, we show a preferable variation of two L-shaped ink containers (11a & 11b) on the two sides of the paper (10), and the paper moving between them for example from the top down or from the bottom upwards. In this case the ink containers can be for example in an “L” shape for the left head and opposite “L” shape for the right head so that the heads are at the preferably horizontal or less vertical ends of the containers and face each other, and the vertical parts can take advantage of normal gravity to move the ink towards the printing elements of the heads. Preferably the “L”'s are slightly wider on top in order to allow for more ink to be included. As explained above in the reference to FIG. 1, this is just an example and many other shapes can also be used.

Referring to FIG. 2, we show a similar configuration to the one described in FIG. 1, except that there is a slight shift in the positions of the rollers (22a-22b) and heads (21a-2b) between the 2 sides of the paper (20). In this configuration the heads can be even more easily allowed to move sideways (right and left on the paper) independently of each other, however the paper may be less stable than in the version of FIG. 1. However this is just one possible example. A better variation is for example that the rollers are facing each other in pairs like in FIG. 1 and only the printing heads are slightly shifted in position.

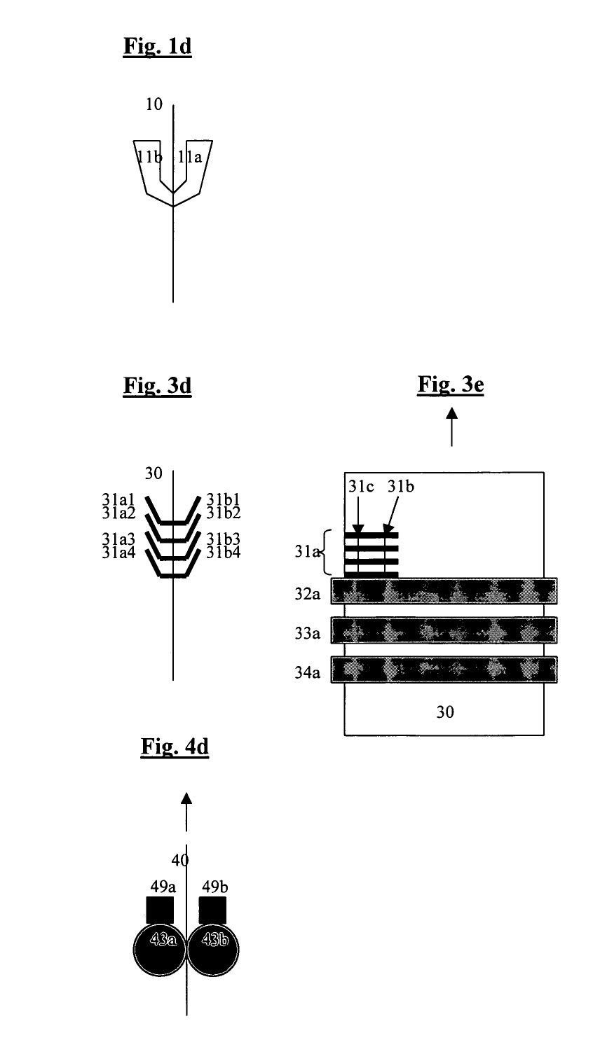

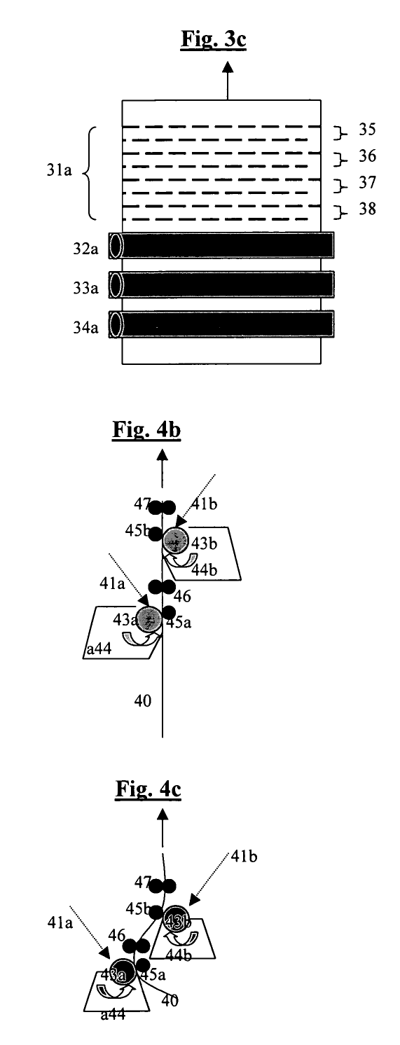

Referring to FIGS. 3a-b, we show a side view and a top view, respectively, of a preferable version where the printing heads (31a &b) are elongated and non-moving. These printing heads preferably each deal with one color. The paper (30) is, again, moving through preferably a group of rollers (such as for example 32a-b-34a-b) for increased stability, with the rollers closer to the heads preferably pulling stronger. The top arrow, again, shows the direction of the movement of the paper. Eventhough, for clarity of the illustration, the heads are shown relatively away from each other and from the first roller-set, in practice the elongated non-moving heads (31a-b) are preferably as close as possible together and are also as close as possible to the first roller-set 32a-b. Another possible variation, as explained in the summary, is that there is also some additional gap between each two adjacent color heads in order to further give the ink a chance to dry a little before the paper enters the position of the next printing head. However in this case, since this increases the distance between the farther heads to the last set of elongated rollers before the paper reaches the elongated printing heads, preferably each or at least some of the elongated head include their own support for the paper, and also the paper's possible movement sideways is preferably as limited as possible (at least at the positions of the heads) in order to avoid sideways fluctuations during the movement of the paper that can cause mismatching in the positions of colors that should be on the same spots. In the most extreme variation of this, the various heads are spread more or less evenly in the direction of the movement of the paper, with a few centimeter distance between each two adjacent colors. One way of getting rid of the need to move the head sideways is using for example one elongated head for each color with an elongated ink container and using a small number of piezoelectric elements (at least 2) in the elongated head and using for example an interference between two or more mechanical/sound resonance waves created for example by making the various piezoelectric elements (by electrical means) vibrate at certain frequencies and strengths in order to create a stationary wave that can cause any part along the width of the head to vibrate and thus exert pressure on the toner at the appropriate position. By varying this wave pattern, the pressure points can move from right to left or vice versa very fast without the need to physically move any mechanical parts. The interference behavior depends also on the viscosity of the ink fluid and the speed of sound conduction in it. Another variation of this is to cover the ink with a surface that responds best to these vibrations, so that this surface exerts the pressure on the ink. Another variation is breaking up each elongated head to a number of smaller elongated heads, preferably like a pair of two broken lines with a shift in the breaks between the two lines, as shown in FIG. 3c. Another variation is using, instead of the piezoelectric elements, preferably strong magnets with electromagnetic coils around them, so that the coils can be similarly caused to vibrate by electromagnetic means, again, either as 1-piece long heads, or broken into smaller elongated heads. This can be cheaper than current state-of-the-art moving heads, and also print faster. However, unlike the moving heads, which typically print at each point a number of horizontal pixel-lines, each elongated head preferably prints only a single pixel-line at each step or just a small number of pixel-lines, since this way it is cheaper and can be more efficiently controlled. However, other methods for creating pressure at various points without moving mechanical parts can also be used, and configurations might be also made where they print more than one pixel-line at a time. For example, a matrix of small piezoelectric elements can be used throughout the length of the head, however this can be much more expensive. Another variation is using instead a matrix of small heat elements throughout the length of the head, which can be accomplished by a variety of ways (for example, normal heating elements, or small crystals that become warm when electricity is passed through them, or an array similar to a cross-bar memory in which moving a current in two required x-y wires can create a spike at their intersection, etc.). This matrix or array of heating elements should be relatively cheap. Since the elongated head for each color works independently like in a production line, and since the elements in each pixel-line can be accessed very fast serially or even in parallel, this has also the advantage of being able to print much faster than current state-of the-art inkjet printers, and also printing in color takes the same time as printing in black, unlike normal inkjets which typically have some delay between colors and therefore print slower in colors, and this of course, in addition to the effect of further doubling the speed by printing on both sides of the paper at the same time. Another advantage is that each ink container (with or without its head) can be changed when the ink runs out or the head gets destroyed, independently of the other colors, which is more efficient. Preferably, to save costs, the matrix of piezoelectric elements or heat elements is made thinner so that it prints only a single pixel-line, so it is actually an array. Also, in such matrices or arrays, preferably there are a number of pressure sensors along the elongated head, which monitor all the time the amount of ink, and a pressure-balancing system, which makes sure the ink will flow evenly to fill the length of the head, and preferably the ink is more fluid. The pressure-balancing can be done for example with the aid of air pressure or springs. Like in FIG. 1, the heads can be for example one group above the paper and one group below it, and then the heads that are below the paper preferably rely for example on springs and/or air pressure and/or capillary focres instead of gravity, or the heads are on the two sides and the paper moves for example from the top downwards or from the bottom upwards. Also, the variation of using “L” shaped ink containers can be used also with the elongated containers, so the “L” shape continues throughout the length of the container, as shown in FIG. 3d. Of course, the input and output trays preferably can still be horizontally oriented. However various other angles for the input and output trays and for the paper path near the heads may also be used, and also the heads and/or the ink containers may be also at other orientations and/or angles and/or positions and/or shapes. Another problem with the elongated heads is that in normal moving heads typically the head can be cleaned (for example by some cleaning pad) when it reaches the end of the line in order to get rid of paint residues, but this can't be done like this with elongated stationary heads. Therefore, preferably, the heads are cleaned for example by an attached elongated pad that moves for example by rotation from their side to their bottom, preferably after each page has been finished. This should be sufficient since the cleaning is mainly intended to keep the holes from getting blocked by ink drying-up in them. Preferably these pads also remain as seals when there is no paper in order to keep the ink from drying. Another possible variation is one elongated head on each side of the paper, which has access to all 4 color containers, for example by printing at each step of the paper advancement a number of pixel-lines in parallel, so that at least 1 pixel-line comes from each ink container, or by operating the elongated stationary head in a way that accesses all the colors by some wait cycle, however this is less efficient and can cause more problems. Like in the other versions, with the elongated heads there can also be the variation that the heads are shifted in position between the two sides of the paper, in a way similar to FIG. 2, and preferably they are used together with the side devices shown in FIGS. 1a-c. Of course, the various variations of elongated heads can also be used for speeding-up printing and reducing the mechanical parts also in one-sided printers.

Referring to FIG. 3c, we show another variation, in which each of the elongated heads (31a) is broken into a number of smaller elongated heads, preferably like two broken lines (35-38) with a shift in the breaks between the two lines, so that together each two lines cover the entire width without gaps. This way the vibrations can move faster since each smaller head can vibrate independently of the others, with either a separate ink container attached to each, or some connection between them and a common ink container for each color. Preferably, each small head has at least 2 piezoelectric elements, preferably at its edges, or, in another version, electromagnetic elements instead. Preferably each of the 4 pairs of lines of small elongated heads are connected to a single ink container (on each side of the paper). In addition to this, the same side devices and/or static electricity described in FIGS. 1 & 1a-c for further stabilizing the paper can also be used in the version with the elongated heads.

Referring to FIG. 3d, we show a preferable variation of using elongated containers (31a1 . . . 31a4, 31b1 . . . 31b4) on the two sides of the paper, and the paper (30) moving between them for example from the top down or from the bottom upwards. In this case the ink containers can be for example in an “L” shape for the left head and opposite “L” shape for the right head so that the heads are at the horizontal ends of the containers and face each other, and the vertical parts can take advantage of normal gravity to move the ink towards the printing elements of the heads. Preferably the “L”'s are slightly wider on top in order to allow for more ink to be included. As explained above in the reference to FIGS. 3a-b, this is just an example and many other shapes can also be used.

Referring to FIG. 3e, we show another variation wherein the color heads (31a) are either elongated and connected for example by elements 31b & 31c, or are of normal size, and are moving normally, except that they spaced in the direction of the movement of the paper instead of sideways. Preferably they are as close as possible to the rollers that stretch the paper (32a-34a) but they can also be with larger distances between them and in that case at least some of them preferably also include their own support for the paper. The advantages and features of this direction of spreading the color heads are explained in the patent summary.

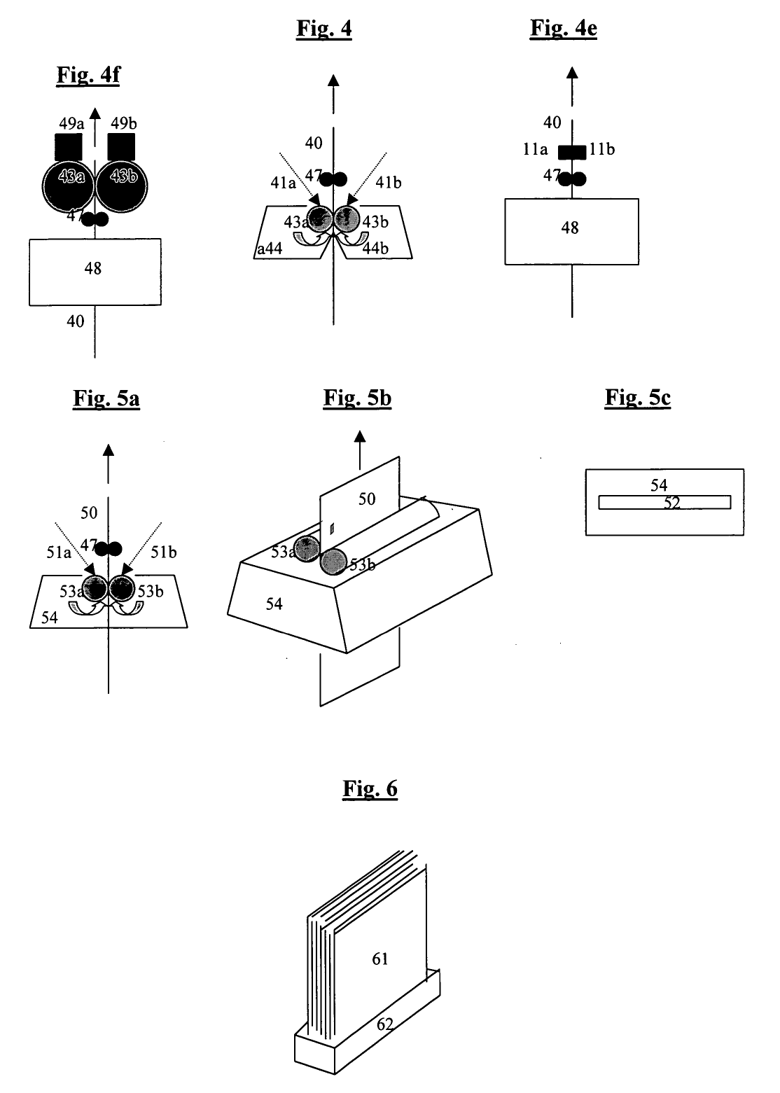

Referring to FIG. 4, we show an illustration of a side-view cross-section of a preferable way that the two drums (43a & 43b) in the laser printer are facing each other in two cartridges (44a & 44b) close to each other and the paper (40) passes between them, moving in the direction of the top arrow. The two drums (43a & 43b) rotate in the directions shown by the two round arrows. As can be seen from the drawing, preferably the two drums are positioned side by side and are preferably shifted towards each other at the corners of the cartridges so that there is no problem of spilling powder, which could occur for example if one drum was below the paper and one above, and the paper preferably either moves from the bottom up or from the top down. Of course, the input and output trays preferably can still be horizontally oriented. This means that preferably the drums are arranged so that one is closer to the user and one is farther from the user. However various other angles for the input and output trays and for the paper path near the drums may also be used, and also the cartridges and/or the drums may be also at other orientations and/or angles and/or positions. And if color printing is used, then preferably more cartridges and toners are used for each side of the paper. Preferably one or both of the two drums (43a & 43b) and/or one or both of the two cartridges (44a & 44b) can be moved a little sideways as needed and preferably contains also a spring that pushes it towards the other drum, and preferably there is a sensor or sensors (for example optical or mechanical) that can detect if there is a paper between the drums or not. If there is no paper, then preferably the drums are automatically moved a little away from each other so that they don't touch each other in order not to scratch or damage each other. Preferably both drums are controlled by a common set of toothed wheels or relays or bands, in order to make sure that the two drums move in good coordination with each other. Eventhough, for clarity of the illustration, the drums (43a & 43b) are shown relatively small compared to the size of the cartridges (44a & 44b), in practice they are preferably a little bigger and fill-up more space in the cartridges, because this allows better reaching to the toner-powder that fills the cartridges and, also, because larger drums have less circular distortion at the line where they intersect with the paper. Anyway, any such distortion is preferably fixed for example by focusing the laser beams (41a and 41b) (or the light from the LED arrays) in a way that each pixel is slightly compressed in its height, so that after the circular distortion caused by the arching of the drum, the pixel will emerge round again. As can be seen, there is quite a large range of angles that can be used for applying the laser beams from both sides of the paper (or the light from the LED arrays) (41a and 41b). In addition to this, side devices and/or static electricity similar to those described in FIGS. 1&1a-c for further stabilizing the paper can also be used together with these embodiments. Preferably the toner images of both sides are fixed simultaneously at element 47. As explained in the summary, if it is a color printer, preferably the paper moves between a number of pairs of cartridges, preferably each pair above the other pair.

Referring to FIG. 4b, we show an illustration of a side-view cross-section of another variation in which the two drums (43a & 43b) in the laser printer are facing each other in two cartridges (44a & 44b) with a certain shift in their position and the paper (40) passes between them and preferably a counter-roller (45a, 45b) facing each of them, which is preferably covered with an inert material that does not interact with the toner, such as for example Teflon or diamond coating. This counter-roller can be for example full-width, or only at the page margins. Another variation of this variation is to add also between the positions of the two drums an additional element (46) that fixes the powder preferably by heat and pressure or by other means, so that the powder on each pixel-line of the 1^{st} side of the paper is already set when the corresponding pixel-line on the other side of the paper enters the second drum, and then the pixel-lines of the second side are fixed at element 47. Other variations are also possible, such as for example giving the paper some bending between the two cartridges, so that the paper doesn't move straight up or straight down but can also enter each of the two cartridges at other angles, which also don't have to be the same for both cartridges, as shown in FIG. 4c as one of many possible examples. Also the cartridges and/or the drums may be also at other orientations and/or angles and/or positions. In addition to this, side devices and/or static electricity similar to those described in FIGS. 1&1a-c for further stabilizing the paper can also be used together with these embodiments.

Referring to FIG. 4c we show another example of a side-view cross-section of a variation in which the two drums (43a & 43b) in the laser printer are less facing each other in the two cartridges (44a & 44b) with a certain shift in their position and the paper (40) passes between them with a preferably slight bending between them and preferably a small counter-roller (45a, 45b) facing each of them. This counter-roller can be for example full-width, or only at the page margins. Another variation of this variation is to add also between the positions of the two drums an additional element (46) that fixes the powder by heat and pressure, so that the powder on each pixel-line of the 1^{st} side of the paper is already set when the corresponding pixel-line on the other side of the paper enters the second drum, and then the pixel-lines of the second side are fixed at element 47.

Referring to FIG. 4d, we show a side-view cross-section illustration of a preferable way that the drums (43a & 43b) are facing each other in solid ink printers that use drums, and the paper (40) passes between them and preferably a separate set of solid inks and printing heads (49a & 49b) is used with each drum. Like with ink-jet printers, the heads can move back and forth sideways, and the colors can be for example next to each other either in the direction of this movement or in 90 degrees to it (or at other angles). Like in FIG. 4, Preferably one or both of the two drums (43a & 43b) can be moved a little sideways as needed and preferably contains also a spring that pushes it towards the other drum, and preferably there is a sensor or sensors (for example optical or mechanical) that can detect if there is a paper between the drums or not. If there is no paper, then preferably the drums are automatically moved a little away from each other so that they don't touch each other in order not to scratch or damage each other. When printing only on one side, preferably the drum in the unused side is automatically moved slightly away from the paper so that it doesn't have to touch it, which saves unnecessary wear of the unused drum. In this case, if the drums are facing each other without a shift in the printing position, preferably when the drum in the unused side is automatically moved slightly away, another counter-roller is pushed into position instead. However, since these drums are typically stronger than drums used in laser cartridges, another possible variation is to use the second drum normally as a counter-roller even when printing only from one of the drums. Preferably both drums are controlled by a common set of toothed wheels or relays or bands, in order to make sure that the two drums move in good coordination with each other. As explained in the summary and in other variations, this is just an example and there can be also a preferably slight shift in the printing positions between the two sides of the paper, and also the paper can move in other directions and the drums and/or printing heads and or solid inks can be also at other positions and/or/angles and/or orientations. For example, although the heads are shown above the drums, which is more preferable for gravity considerations, this is just an example and they can also be at other positions or orientations on the drums. Another possible variation, like in the ink-jet, could be to use for example elongated stationary or moving heads, preferably with elongated solid inks, however in this variation the ink is preferably melted into liquid (for example by heating) and re-solidified often in order to redistribute it evenly (preferably after the printing batch, so that during consecutive printing preferably it is kept liquid). Another possible variation, like in the ink-jet, is to use normal color heads, but space them in the direction of the movement of the paper, preferably with some additional gap between each two adjacent color heads instead of sideways, in order to enable higher speeds of the heads and of the paper movement without the colors interfering which each other and/or higher resolutions. These variations with solid ink printers can be used both in variations where the printing is directly on the paper and in variations where the printing is through an intermediary drum or drums on each side of the paper. Another possible variation can be for example to use elongated heads with non-elongated solid inks, so that each time only the tip of the ink is melted and the liquid can flow within the head (or within an elongated ink buffer near the head) to the positions needed. Again, these improvements can be used also for example with 1-sided printers independently of other features of this invention.

Referring to FIGS. 4e-f, we show a preferable variation in which preferably after exiting the fixing elements (47) of the laser printing unit (48), which is preferably designed for example like in FIGS. 4-4d or 5a-b, the page (40) reaches Inkjet printing heads 11a & b (which can be also for example solid ink print heads) or for example reaches drums 43a & 43b that are coupled to solid ink printing heads 49a & 49b, that can add color where needed. The advantages of this are explained in the patent summary. This has the further advantage that since the paper is still hot at this stage the ink droplets will also dry faster and thus avoid smearing and thus possibly also enable faster inkjet. (or solid ink) printing and/or improve the resolution.

Actually there are a number of relevant patents about such hybrid printers, and especially U.S. Pat. No. 5,373,530, issued on Dec. 13, 1994 to Xerox, U.S. Pat. No. 5,570,451, issued on Oct. 29, 1996 to Cannon, U.S. Pat. No. 5,751,299 issued on May 12, 1998 to Lexmark, and U.S. Pat. No. 5,760,928, issued on Jun. 2, 1998 to Cannon. The Xerox patent uses printing of the ink jet before that toner from the laser printer is fixed, claiming that it cannot be done after the fixing (without explaining why), and refers to the color only as a way to add a few annotations, not as a full integration between laser and inkjet printing. It also mentions the possibility of using a full-width inkjet printhead or a set of more than one inkjet printhead for increasing the speed of he inkjet unit, but they do not explain how the elongated full-width heads work or relate to the problems involved in implementing that. They also mention the possibility of partial heating for partial fixing of the toner before reaching the inkjet position. But they ignore the possibility that such partial heating without proper fixing might cause the toner to smear or be distorted. The first Cannon patent adds the possibility of using separate paper paths if the page is printed only in B/W, only in Color or in combination, and the possibility of using a 2^{nd} stacking unit before entering the 2^{nd} printing unit. However, such additions would make the printer much less compact and more expensive. However, the last 2 patents explain that the biggest problem with such combination is to align the color parts with the black parts at the exact same places, which is further complicated by the fact that the paper shrinks a little because of the heat of the laser printer fixing elements, and conversely, if the ink jet is applied before the laser, the paper can expand and become wavy before entering the laser unit. In addition, according to the Lexmark patent, while it is generally advantageous for print quality from ink jet printing to print on warm, dry papers, fusers generally employ silicone oil as a release agent and residue of that from the fusing process can interfere with the wettability of the ink jet inks. Also, heat from the paper can cause ink to harden in the nozzles of an ink jet printer, thereby rendering the ink jet printer non-functional, and therefore the inkjet should be used before the fusing of the laser toner, and also they suggest adding an electrical charge to the inkjet printhead to repel stray toner. However they do not consider the possibility that squirting the ink droplets might still disturb the toner if it has not been fixed yet, especially for example if the inkjet printheads have an electrical charge. And of course this would be even much more complicated if simultaneous duplex printing is used, which means that there is loose toner on both sides of the paper, to be followed by inkjet print heads on both'sides of the paper. They also mention the possibility of using a page-wide inkjet printhead, but without explaining how it works. The Lexmark solution to the alignment problem is let the paper reach the inkjet printhead while it is still on the same large roller that was used during the laser printing or on the same belt, so that the exact paper position can be kept more easily. However, clearly such a solution cannot be used with simultaneous double-sided printing. The 2^{nd} Cannon patent actually describes only a photocopying process and the solution is to analyze the blackness level of various regions so that that when the gray signal is larger than the predetermined threshold value, it is determined that the corresponding region is a character or solid black portion, and image formation is performed by only the electrophotography method; otherwise, image formation is performed by only the ink-jet method. However, such a solution is obviously limited since it means for example that images areas with more than a certain percent of black will automatically be printed only in Black/white/gray levels without color.

So preferably in the current invention no silicon oil is used at the laser toner fusers or it is properly contained so that no oil residue reaches the paper and the paper can still absorb the ink with no problem. This is no problem since in properly functioning printers indeed either no silicon oil is used or it does not reach the paper. At least in one of the variations of this the fixing element of the laser itself can be used as the last set of rollers before reaching the printing heads, however preferably it is not too close to the heads in order not to heat too much the printing heads themselves, so another variation is for example to add another set of rollers to stabilize the paper before it reaches the printing heads. In addition, preferably the paper and/or the inkjet print heads are cooled at least partially for example by a ventilator and/or a heat sink, so that when it reaches the inkjet printheads the paper is preferably still hot but not hot enough to harden the ink within the printhead nozzles. However, for this to work properly, preferably the laser unit and the inkjet (or solid ink) unit both use precise positioning of the paper for example by any of the methods described in this invention so that for example if a colored headline or text is used within a black text, it appears on the correct place, and the paper is preferably prevented from sideways fluctuations, and/or for example sensors can detect any such fluctuations and correct the paper's position and/or the printing elements' position accordingly and/or use this data to let the inkjet printing heads take this logically into account. Preferably the paper is stabilized for example by any of the methods described in this invention for simultaneous double sided printing. Preferably the right-left positioning can be done for example by using the tilted side rollers described in FIG. 1b (and/or the rollers with a screw shape of FIG. 1c) together with a side border at least on one side (for example the right side), and preferably the rollers on that side are more tilted than the rollers on the other side (for example the left side), so that the paper always has a tendency to stay near at the right border (or this is designed for example vice versa—so that the paper stays always near a left border). Preferably the rollers are large enough to accommodate various types of paper such as for example A4, letter, etc. Of course this is just an example and many additional mechanisms can also be used. The sensing is preferably done on the position of the paper margins and/or on the position of the laser printing, preferably by using for example one or more reference marks in black or for example at least one UV mark that is done preferably by an element that is always at the same position in the laser unit. In addition, preferably the inkjet printheads have or use exactly the same margin size and the same pixel size (both horizontally and vertically) as the laser unit, otherwise there would be misalignments between the pixels printed by the laser unit and the pixels printed by the inkjet printheads even if the paper is at exactly the same position. If the paper shrinks a little by the heat or expands a little when wetted by the inkjet preferably this is taken in account in advance by this matching of pixel sizes and margin sizes, so that the matching remains OK under these conditions. (Preferably, if there remains a difference, the laser pixel size is adjusted logically to fit the inkjet pixel since that is more easy, however it might be done also for example logically by the inkjet printheads for example if the inkjet heads are moving). Another possible variation is that when the percent of black in comparison to color on a certain page is below a certain threshold, the printer can preferably automatically decide to use only the inkjet for that page, in order to achieve more precise mixing. A better variation is that this can be done also for individual parts of the page, preferably based on automatically treating image areas and text areas differently, so that for example if the page contains one or more images that have also black pixels, and the rest is black text, the printer preferably automatically lets the inkjet unit print alone the images (or at least less dark areas in them) and can automatically decide for example to print only the black text part in the laser unit, thus using preferably only the inkjet's (or solid ink's) black for the pictures. This automatic different handling of text sections and image (picture) sections is much more preferable than the above Cannon solution, since this way the image will always be printed properly and in color even if it contains black above the threshold, unless for example the user explicitly requests to print it in B/W/gray. Alternately, another variation is that the inkjet (or solid ink) for example does not have black at all, which further reduces costs, and all the black printing is done by the laser, however that requires very precise alignment of the paper and of the inkjet printheads so that there is no mismatch between the color and the B/W parts. In all of these variations, preferably in the portions of the page where there is no color the feeder lets the page move faster, so that the addition of colors only slows down the printing by a minimum percent. However, to accomplish the above variation and also to allow slowing the paper as needed (and thus improve the average speed), preferably the page enters the Inkjet (or solid ink) unit only after is has finished exiting from the fixing elements, or after the page at least exited already from the drums and the fixing elements can be made to move faster or slower without adversely affecting the fixing of the toner, or the color printing heads can also move in the direction of the movement of the paper and thus to jump over places where color is not needed without having to wait for the paper (but this is less preferable since it takes more space and requires more mechanics). Another problem is that if the page is for example full color and the inkjet (or solid ink) unit works too slow compared to the speed of the laser unit, the laser unit needs to be able to adjust to this. Therefore a more preferable variation is to use a color unit that is fast enough to work at the same speed as the laser unit. With solid ink that uses drums this is no problem since it can typically easily match the laser speed, and other variations are using for example the elongated heads or preferably other variations that were discussed in this patent for speeding up the printing. Another possible variation is that when needed the laser unit can either slow down the entire production line as needed or stop it temporarily and speed it up again as soon as possible. Another possible variation is to enable the color unit to slow down the page independently, as explained above. Another possible variation is that the printer is able to use for example a temporary buffer for storing pages and preferably an option for routing pages independently to the laser unit or to the color unit, and thus the inkjet (or solid ink) unit and laser unit can preferably also work in parallel when needed, however as explained above this is less preferable since it involves more mechanics and complications and can make the printer less compact, so it is more appropriate for more expensive industrial version of this. Another possible variation is that preferably the software of the printer (i.e. for example the driver and/or the firmware) and/or of applications that use the printer, such as for example editors (such as for example Word) or Internet browsers can automatically treat text and images differently, so that if for example a page containing mostly blue text is sent for printing the printer can automatically decide to convert the text to black and send it for the laser unit for printing, and if for example the text is mainly black but contains some blue (for example in html links), the blue will preferably remain blue by printing these parts of the text through the Inkjet printheads (and similarly of course for other text colors, so for example if most of the text is blue and there are a few emphasized red lines, the printer can decide for example to convert the leading color to black and print only the few red texts through the inkjet), and as explained above the picture area is preferably automatically printed only by the inkjet unit, unless the user explicitly requests otherwise. (This is, again, much more sophisticated and flexible than the Cannon solution). In addition, preferably the user can choose and mark various options in connection with this in the printer software and/or in the applications that use the printer, for example enabling or disabling the above automatic decision making and/or specifying other defaults or rules. Also, the user preferably has the choice of telling the printer to set Off the inkjet (or solid ink) part, in which case the printer behaves like a normal laser printer (Since preferably no special path is used for reaching the inkjet printheads, preferably this simply means that in this mode the Inkjet printheads simply don't do anything as the paper passes near them, and the laser unit knows that is has to print the page normally and ignore the inkjet system. This is much more preferable than having three separate paper paths like in the above first Cannon patent). In all of the above variations, preferably the laser unit is able, when the inkjet (or solid ink) option is set to On, to decide which pixels or areas are in color and therefore should be transferred to the inkjet (or solid ink) unit for printing, so that both units can work in coordination with each other. The inkjet (or solid ink) printing heads are also preferably duplex, preferably in any of the methods described in this invention. Of course, various combinations of the above variations are also possible. These variations can be used also with other types of printing that can add color, although it is cheaper do to it with an inkjet unit. Similar combinations might be used also used between other types of fast black and color printers that may exist in the future. Of course, these printing principles can be applied also for example in Fax machines and/or photo-copiers and/or for example machines that combine a printer with a photocopier and/or Fax, etc., and/or any other device that contains printing elements. This can apply also to any other features of this invention. (Of course, if it is for example within a Fax or a photocopier then preferably there are also color scanner elements and/or duplex scanning elements accordingly).

Referring to FIGS. 5a-c, we show a side-view, 3-d view, and bottom-view, respectively, of a preferable version where a single cartridge (54) with two drums (53a & 53b) is used. Again, for clarity of the illustration, the drums (53a & b) are shown smaller than they preferably are, compared to the size of the cartridge (54). The paper (50) preferably enters through a slit (52) in the bottom of the cartridge (54), and, preferably, this slit (52) is surrounded by 4 internal walls going up, so that no toner powder can be spilled through the slit. However, the toner from the two main parts can move from side to side around these internal walls. Other variations are also possible, such as, for example, the paper entering the cartridge from the side, but the variation shown is more convenient. In addition to this, side devices and/or static electricity similar to those described in FIGS. 1&1a-c for further stabilizing the paper can also be used together with these embodiments. Also, like in FIG. 4b, the single cartridge can be extended so that there is a certain shift between the positions where each of the two drums touch the paper, so it would look similar to FIG. 4b, except that the two cartridges are connected and powder can move between both of them. In this case preferably there is also a preferably small counter-roller for each drum, so that that the paper passes near each drum between it and its counter-roller. Another possible variation in this case is that the drums are a little shifted also horizontally, causing the paper to bend a little around the point of touching the drum, which can force it near each drum and increase the area of touching the drum even without the need for internal counter-rollers. Also, of course, like in the case of two (or more) cartridges, the cartridge and/or the drums (both if they are at the same printing position or with a certain shift) and/or slits, may be also at other orientations and/or angles and/or positions. Another possible variation is that if it is a single cartridge, the paper might even pass for example between two drums that are one below the paper and one above it, since this way there is no spilling problem, but in this case preferably there is a mechanism for ensuring proper toner circulation within the cartridge, for example by a mechanical brush inside the cartridge, or electrostatic force, or air suction, etc. Preferably the toner images of both sides are fixed simultaneously at element 47. Of course, if it is a color laser (or LED) printer, preferably there are additional dual-side cartridges like this for the other colors, preferably above each other. Preferably the cartridge can be easily opened in case a paper ever gets stuck and needs to be cleared.

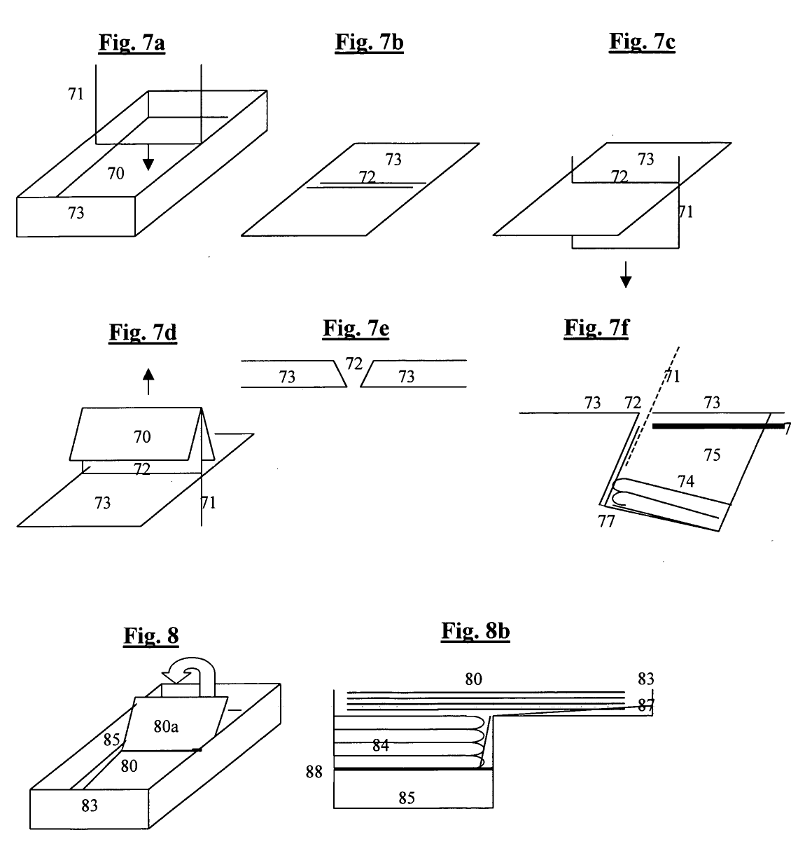

Referring to FIG. 6, we show an illustration of a preferable way that a bunch of papers (61) can be glued together at one of their edges in a container (62) that is large enough to contain at least the back of the group of papers (61). Such a process can be used for either gluing a group of single papers, or for gluing together bunches of previously preferably stitched folded papers which can be created for example in any of the methods shown in FIGS. 7-8. The pages can be slid into this vertical position for example by rollers that lead them to a vertical guide from an originally vertical tray, or for example the tray itself can turn around from horizontal position to vertical position. This way the tips of the pages can be dipped into some preferably liquid or semi-liquid glue. Preferably the pages are slightly separated from each other, for example by applying an electrostatic charge to them (and/or some ultrasound to shake them) so that the glue has a chance to enter also between them at the edges. The glue can be solidified for example by heating (such as for example through UV radiation, or ultrasound or by other means), or by mixing two substances, such as for example in epoxy glues, etc. Another variation, which can save the need to turn the pages to the vertical position, is to use, for example, a cardboard or plastic for the book cover which is made already in the shape of the front cover, the back cover, and the back strip—all connected in one piece, and with glue already contained in the inner face of the back-strip. This cardboard can be for example fed-in from a separate special tray, and by simply pressing the pages (or groups of previously stitched folded papers) to the back strip and for example warming it, the pages or groups of pages are joined together with the glue. Another variation is using pages that are already pre-covered for example with small dots or strips of for example plastic or glue at one of the edges on one or both sides of that edge, or for example to automatically cover each page with such a material preferably after it has been printed, for example by using a roll of such plastic or flexible solid glue fed separately, and then simply using for example heat or UV radiation or ultrasonic waves to soldier all of this together at the back of the book. The only problem is that using pre-covered pages might make the pages thicker at the plastic (or glue) covered-end, which might tilt them a little during the feeding process. One solution is for example to enable a slight tilting of the bottom of the input tray on the opposite side, which compensates for the tilt caused by the extra-width on the plastic-covered side. Another solution is to use pre-processed pages that have the plastic (or glue) inserted in small holes at the edge, so that the plastic or glue does not make the page thicker there. Of course if this method is used for gluing the pages after folding and cutting them in the middle then this said plastic or glue can be instead in the middle of each original sheet of paper, preferably on both sides of it, however it can still be in the edge instead of in the middle but then the pages are glued at the edge and not in the middle after folding so this has to be taken into account preferably by the software or firmware while planning the arrangement of the printed faces (this is also another solution to the thickness problem since in this variation preferably each paper is covered with this material on the two smaller edges). Another possible variation is that for example a stripe of preferably solid glue is in the middle of each page, preferably on both sides of the page, and after folding bunches of pages together for example by any of the methods described in the references to FIGS. 7a-f or 8a-b, for example by combination of heat or ultrasonic waves and pressure, the glue binds together both the pages within each bundle and the different bundles to each other and preferably also to the cover. However, in all the variations where for example plastic or glue is already on the paper in advance, preferably this glue or plastic is made so that it does not smear or stick for example when pressed by the heating and fixing element of laser printers, which can be accomplished for example by using materials that stick only when meeting another material of the same kind, or by using for example some type of epoxy or similar glue, so that for example the pages all have one of the two materials at their edge and preferably the inner side of the cover has the other material that is needed for the binding. Another possible solution is using for example glue or plastic with higher thermal capacitance or higher melting point so that it is less affected by the short exposure to the fixing elements in Laser printers. Another possible solution in the variations where the glue or plastic is only at the edge of each paper is that the fixing elements for example in laser printers are made a little shorter than the width of the paper so they don't touch the edge with the glue. Anyway, if the paper is pre-covered with the adhesive material, the variations where it is on the side are more preferable than the variations where it is on the middle since having it in the middle precludes using the same types of pages also for normal 1-sided or 2-sided printing, whereas having it on the edge allows more versatility. Another solution is to cover the edge of each page with this plastic during the feeding process—for example after each page is printed. Another variation is simply automatically stapling the group of pages at the appropriate edge with one or more long staples throughout the entire width of the group of papers, or using other mechanical means of forcing them together, such as for example a strong spring at the edge that forcibly holds all the pages together. Of course, various combinations of the above and other variations are also possible.

Referring to FIGS. 7a-f, we show an illustration of a preferable way that a group of printed papers (70) can be folded together in the middle, in order to be either cut at the fold or stitched at the fold. After printing, the group of papers (for example 6-12 papers, or other numbers) is in an output tray (73), which has in the middle a slit (72). A solid element such as for example a board or wire-frame (71) is then inserted from the slit (either from above or from below, but for the illustration it is shown entering from above), and pushes the group of papers through the slit and thus folds them in the middle. FIG. 7d shows how the pages folded on top of the board or frame look like after it has been inserted (in this case, it is a reversed view from the bottom since the board or frame came-in from above). The entry angle of this board or frame can either be at 90 degrees to the tray, or at other convenient tilted angles, in order to save space. Preferably the edge of the board or frame that pushes the papers has one or more small sockets in it shaped like in the bottom part of a stapler, so that staples can be pushed from outside and closed within the folded paper by pressing them against these sockets. Other methods of connecting the pages within the group are also possible. If the book is made as 4 faces from each paper-sheet (2 faces per each side of the paper), then these stitched groups are preferably later glued or stapled together as explained in FIG. 6. If the book is made for example as 8 faces from each sheet of paper, then at this stage, instead of stitching, the papers are preferably cut at the fold, and a second fold is similarly done with the new group of smaller pages, this time ending with a stitch at the new smaller fold. For home and office printers using standard paper there is no need for further cutting and folding, although the same principle can be used also for larger industrial printing with larger sheets of paper and then more than 2 such stages can also be used. Another variation is using just one stage of folding, so that if the user wants a book with smaller-sized pages, he has to insert smaller pages (either in the same tray, which can be adjusted also to smaller pages, or in a separate tray). Another variation is that the printer can also cut a little the open edges of the folded groups in order to compensate for the slight distortion caused by the folding, which makes the external pages in each group slightly shorter at the other edge than the internal pages. However, with small groups of pages this is not a significant problem since it can be hardly noticeable anyway. If rolled (or folded) continuous paper is used instead of separate sheets of paper, then there can be more flexibility in the types of folds, and the pages can be for example folded also in a concertina-like manner before cutting and then for example one side is preferably glued together. Another possible variation is shown in FIG. 7e, which is a close-up side-view cross-section of the slit area (72) in the bottom of the tray (73). If the pushing element (71) comes for example from the top down then in this variation preferably the slit (72) is a little wider on the top of the tray floor than on the bottom of the floor in order to further help guide the sheets or paper smoothly through the slit. FIG. 7f shows in more detail a few preferable possible variations of what happens to the folded groups of paper (74) after being pushed through the slit: They can enter for example a tilted smaller container (75) below the first half of the output tray (73), so that each time after the pushing element (71) moves out, the newly folded group of papers (74) falls by gravitational forces to the side, so that the folded groups of paper lie down stacked on top of each other, so that they can be for example glued together at their ends or stitched together by other means. The staples can be entered into each bunch of folded papers for example by an additional side element (76) near the slit (72). Preferably, for each book a cover of stronger material (77) is first fed automatically or manually into the bottom compartment (75) so that the upper part of the cover is preferably held in parallel to the left wall of the compartment (75) and the bottom part in parallel to the floor of the compartment (75). Preferably this cover (77) contains at its central fold a stronger strip with glue or plastic or other material that can attach to the fold areas of the folded bunches of paper for example by pressure and/or by heat or by similar means. Another possible variation is that this strip contains for example in addition or instead of the glue also small metal elements like staples (for example 1 mm apart of each other) preferably throughout the entire length and width of the strip, so when the moving element (71) pushes down a folded bunch of papers (74) it presses against these staples at the end and the small sockets at the edge of the moving element (71) cause these staples to bend and thus hold the folded bunches at the fold areas. This has the further advantage that fewer moving parts are needed and the staples are already supplied with the cover. Another possible variation is for example small plastic hollow needles containing glue or for example with a small plastic pyramid of glue at their edges, so that when pressed by the edge of the moving element (71) they penetrate each bunch of papers (74) at the fold area and the pyramid containing the glue explodes and the glue holds it in the inner part of each fold. Another possible variation is that the for example plastic needles have for example a pyramid shape at the top even without glue and when pressed against the paper they glide in and get stuck, for example similar to the way that drip heads are added to a plastic water pipe. However, in the versions where such staples or needles are used to attach each bunch (74) at a time to the cover (77) preferably the cover is also automatically pulled down for example by the width of 1 folded bunch at each step of the process. Another possible variation is to use for example a stapling unit pushing staples from the bottom into the strip of the cover when the edge of the moving element (71) presses at it (again, preferably in combination with moving the cover a little at each step), however, this is less preferable since it adds mechanical parts, and also having the staples already in the strip of the cover has the further advantage that the there can be much more staples all over the strip, compared to just a few staple positions if the staples are added by a mechanism inside the printer. Another possible variation is to use no staples at all but to use for example paper with has already a stripe of preferably solid glue preferably on both sides of the paper at the positions of the folds, or add this for example during the folding or any time after the page has been printed (but that is less preferable since it can lead to more maintenance and consumable problems for the printer, although it has the advantage that the glue does not exist while the paper enters the normal heating and fixing elements for example in a laser printer), and then for example by combination of heat or ultrasonic waves and pressure, the glue binds together both the pages within each bundle and the different bundles to each other and to the cover. In this case the binding of the glue by pressure and/or heat or ultrasonic waves can be done for example at each step of pushing a new bunch of folded papers to the cover, or for all of the bunches together at the end. Another possible variation is that for example the printer just creates the folded bunches of pages on top of each other and the user then glues them together for example in a separate unit and adds the cover then. On the other hand if the folded bunches (74) are instead just cut at the fold for example at the end of the displacement of the moving element (71) then gluing them can be simpler, although less strong than with the previous variation, however most soft-cover books today just contain pages glued at their edges. So this can be cheaper, and in fact in this case the whole folding is not needed since the pages can be for example cut in advance before the printing on them or the user can feed smaller pages as needed and then for example the cheaper and simpler solutions described in the reference to FIG. 6 can be used. Preferably the book cover itself is either printed on directly (but that can be difficult if the cover is too thick or has staples or glue in advance or staples at its central stripe), but more preferably the cover images are printed on a separate paper or papers which are later glued manually to the cover by the user. Another possible variation is that if a hybrid laser-inkjet is used then preferably the inkjet heads can be used for the printing directly on the cover, preferably by allowing the inkjet heads more flexibly in moving closer or farther to the cover as needed (for example increasing automatically the gap between them and the cover when the central stripe is reached). Of course various combinations of the above and other variations can also be used.

Referring to FIGS. 8 & 8b, we show an illustration of another preferable way that a group of printed papers (80) in the output tray (83) can be folded together at the middle. In this variation, instead of the moving board or frame, at least part of the tray together with the part of the papers on top of it (80a) is moved around a hinge at the center, in the direction shown by the arrow, preferably with the addition of a horizontal, preferably elongated, element (85) applied from above the papers, at the position of the hinge, preferably parallel to the hinge. This horizontal element (85) is preferably also shaped like a hinge and can be for example moved into position from the side or from above or for example be there all the time so that while printing the printed papers move into the output tray (83) above the floor of the tray and below element 85. Various options similar to the options described in the reference to FIG. 7f are also possible here, except that preferably the folded bunches are removed lower at that half of the tray at each step, as shown in FIG. 8b: Preferably the book cover (87) is initially attached at both ends to the two edges of the output tray (83) and at each stage of folding an additional bunch of newly printed papers (80), the previously folded bunches (84) go down one step as floor (88) goes lower into the lower compartment (85). In this variation if each bunch of folded pages (84) is stitched at each stage to the central stripe of the book cover (87) then, again, these staples are either already at the stripe and are bent by pressing the fold against them, or staples are added from below the cover at the area of the hinge. If staples are added to each bundle at the fold without stitching it at each step to the cover (87), the staples are preferably added at the area of the hinge after the folding, above the cover, or the cover is added only later automatically or by the user. Another possible variation is to use for example a both-sided glue stripe at the fold area of each paper, as explained in the reference to FIGS. 6 and 7a-f. However the variations described in FIGS. 7a-f are more preferable since they are more simple mechanically and with less moving parts.

While the invention has been described with respect to a limited number of embodiments, it will be appreciated that many variations, modifications, expansions and other applications of the invention may be made which are included within the scope of the present invention, as would be obvious to those skilled in the art.

We claim:

1. A system for printing simultaneously on both sides of the page in a printer by using at least one printing element on each side of the paper, without the need for conveyor belts, without the need for stretching the paper between two sets of pairs of rollers and printing between them, without the paper having to make a U-turn around the 2^{nd} printing element, and without the need to base the stabilization on continuous paper, and wherein the printing elements are part of at least one of: A printer, a Fax machine, a photocopier, and any machine that uses printing elements.

2. The system of claim 1 wherein said printer is at least one of an inkjet printer and a solid ink printer that doesn't use a drum, and at least two printing heads are used at least one on each side of the page.

3. The system of claim 2 wherein at least one of the following features exist:
a. Said heads are moving in a synchronized manner sideways at the same time.
b. Said heads move at opposite sideways directions.
c. Said heads each have also at least one moving element that touches the paper as they move, so that the element from both sides of the paper help stabilize the area of the paper being printed upon.
d. Said heads can move sideways independently from each other.
e. At least one roller on each side of the paper is used before the paper reaches the printing heads very close to the position of the printing heads, in order to stabilize the paper.
f. At least one roller at each side of the paper is used before the paper reaches the printing heads very close to the position of the printing heads, in order to stabilize the paper.
g. At least one roller at each side of the paper is used before the paper reaches the printing heads very close to the position of the printing heads, and the rollers closer to the position of the printing heads exert stronger force than the rollers farther from the heads, in order to stretch the paper as it reaches the printing position.
h. Elongated printing heads are used, one for each color, but they are not the full width of the paper and they move sideways.
i. Moving non-elongated printed heads are used, one for each color, but they are spread in the direction of the movement of the paper instead of sideways.
j. More than 4 basic color heads are used apart from black, in order to further improve the percent of covered color combinations.

4. The system of claim 2 wherein the printing heads are stationary elongated heads instead of the normal moving heads, so that each color has it's own elongated printing head, and said elongated print heads are at least one of next to each other and spread with a noticeable gap from each other.

5. The system of claim 4 wherein said elongated stationary heads are implemented by at least one of:
a. Using at least two piezoelectric elements in each elongated head and creating an interference between at least two mechanical resonance waves created by making the various piezoelectric elements vibrate at certain frequencies and strengths.
b. Using at least two magnetic and electromagnetic elements in each elongated head and creating an interference between at least two mechanical resonance waves created by making the various electromagnetic elements vibrate at certain frequencies and strengths.
c. Using a matrix of small piezoelectric elements throughout the length of the head.
d. Using a matrix of small heat elements throughout the length of the head.
e. Using more than 4 elongated color heads apart from black, in order to further improve the percent of covered color combinations.

6. The system of claim 1 wherein said printer is a laser printer and at least one of he following configurations exists:
a. At least two cartridges are used next to each other so that the drums are closely facing each other and the paper can pass between at least two drums at the same time.
b. At least one cartridge is used to deal with both sides of the paper, so that the paper passes between at least one pair of drums that are connected to the same cartridge.

7. The system of claim 1 wherein the printer is a laser printer and at least one of the following features exists:
a. The paper is given a stronger electric charge and the toner powder on both sides of the paper is given a weaker electric charge in order to avoid rejection between the powders from both sides of the paper.
b. The element that fixes the toner to the paper by heat and pressure is as close as possible to the drums in order to avoid smearing.

8. The system of claim 1 wherein said printer is also capable of automatically binding pages together in a book-like form, and said binding is based mainly on gluing the separate pages together at one of their ends.

9. The system of claim 8 wherein said gluing is based on at least one of:
a. Pouring the glue in a container.
b. Feeding a special cover around the book which has the glue on the inner back strip.
c. Covering each page with an appropriate shape and amount of at least one of plastic and adhesive material at the appropriate edge.

10. The system of claim 1 wherein said printer is also capable of automatically binding pages together in a book-like form and said binding is based mainly on mechanically joining the separate pages together.

11. The system of claim 10 wherein at least one of the following features exists:
a. The pages are first joined in groups of folded papers, and said groups are later joined together by at least one of mechanical means and gluing them together.
b. Pages of different sizes have to be already in the right size before inserting them into the printer.
c. The printer can cut the pages to smaller parts before printing on them.
d. The printer can cut the pages to smaller parts after printing on them by first folding them properly and cutting at the fold.
e. The pages are first joined in groups of folded papers, and said groups are later joined together, and said folding is done by at least one of:
Inserting a moving element in a slit in a way that pulls and folds the papers in the middle, and Moving part of the tray around a hinge at the center with a horizontal element applied from above the papers, parallel to the hinge.
f. The pages are first joined in groups of folded papers, and said groups are later joined together, and more than one folding stage can be done, so that at least all the folds before the last fold are followed by cutting the papers at the position of the fold.

12. A method for printing simultaneously on both sides of the page in a printer by using at least one printing element on each side of the paper, without the need for conveyor belts, without the need for stretching the paper between two sets of pairs of rollers and printing between them, without the paper having to make a U-turn around the 2^{nd} printing element, and without the need to base the stabilization on continuous paper, and wherein the printing elements are part of at least one of: A printer, a Fax machine, a photocopier, and any machine that uses printing elements.

13. The method of claim 12 wherein said printer is at least one of an inkjet printer and a solid ink printer that doesn't use a drum, and at least two printing heads are used—at least one on each side of the page.

14. The method of claim 13 wherein at least one of the following features exist:
a. Said heads are moving in a synchronized manner sideways at the same time.
b. Said heads move at opposite sideways directions.
c. Said heads each have also at least one moving element that touches the paper as they move, so that the element from both sides of the paper help stabilize the area of the paper being printed upon.
d. Said heads can move sideways independently from each other.
e. At least one roller on each side of the paper is used before the paper reaches the printing heads very close to the position of the printing heads, in order to stabilize the paper.
f. At least one roller at each side of the paper is used before the paper reaches the printing heads very close to the position of the printing heads, in order to stabilize the paper.
g. At least one roller at each side of the paper is used before the paper reaches the printing heads very close to the position of the printing heads, and the rollers closer to the position of the printing heads exert stronger force than the rollers farther from the heads, in order to stretch the paper as it reaches the printing position.
h. Elongated printing heads are used, one for each color, but they are not the full width of the paper and they move sideways.
i. Moving non-elongated printed heads are used, one for each color, but they are spread in the direction of the movement of the paper instead of sideways.
j. More than 4 basic color heads are used apart from black, in order to further improve the percent of covered color combinations.

15. The method of claim 13 wherein the printing heads are stationary elongated heads instead of the normal moving heads, so that each color has it's own elongated printing head, and said elongated print heads are at least one of next to each other and spread with a noticeable gap from each other.

16. The method of claim 15 wherein said elongated stationary heads are implemented by at least one of:
a. Using at least two piezoelectric elements in each elongated head and creating an interference between at least two mechanical resonance waves created by making the various piezoelectric elements vibrate at certain frequencies and strengths.
b. Using at least two magnetic and electromagnetic elements in each elongated head and creating an interference between at least two mechanical resonance waves created by making the various electromagnetic elements vibrate at certain frequencies and strengths.
c. Using a matrix of small piezoelectric elements throughout the length of the head.
d. Using a matrix of small heat elements throughout the length of the head.
e. Using more than 4 elongated color heads apart from black, in order to further improve the percent of covered color combinations.

17. The method of claim 12 wherein said printer is a laser printer and at least one of he following configurations exists:
a. At least two cartridges are used next to each other so that the drums are closely facing each other and the paper can pass between at least two drums at the same time.
b. At least one cartridge is used to deal with both sides of the paper, so that the paper passes between at least one pair of drums that are connected to the same cartridge.

18. The method of claim 12 wherein the printer is a laser printer and at least one of the following features exists:
a. The paper is given a stronger electric charge and the toner powder on both sides of the paper is given a weaker electric charge in order to avoid rejection between the powders from both sides of the paper.
b. The element that fixes the toner to the paper by heat and pressure is as close as possible to the drums in order to avoid smearing.

19. The method of claim 12 wherein said printer is also capable of automatically binding pages together in a book-like form, and said binding is based mainly on gluing the separate pages together at one of their ends.

20. The method of claim 19 wherein said gluing is based on at least one of:
a. Pouring the glue in a container.
b. Feeding a special cover around the book which has the glue on the inner back strip.
c. Covering each page with an appropriate shape and amount of at least one of plastic and adhesive material at the appropriate edge.

21. The method of claim 12 wherein said printer is also capable of automatically binding pages together in a book-like form and said binding is based mainly on mechanically joining the separate pages together.

22. The method of claim 21 wherein at least one of the following features exists:
a. The pages are first joined in groups of folded papers, and said groups are later joined together by at least one of mechanical means and gluing them together.
b. Pages of different sizes have to be already in the right size before inserting them into the printer.
c. The printer can cut the pages to smaller parts before printing on them.
d. The printer can cut the pages to smaller parts after printing on them by first folding them properly and cutting at the fold.
e. The printer can cut the pages to smaller parts after printing on them by first folding them properly and cutting at the fold, and said folding is done by at least one of: Inserting a moving element in a slit in a way that pulls and folds the papers in the middle, and Moving part of the tray around a hinge at the center with a horizontal element applied from above the papers, parallel to the hinge.
f. The printer can cut the pages to smaller parts after printing on them by first folding them properly and cutting at the fold, and more than one folding stage can be done, so that at least all the folds before the last fold are followed by cutting the papers at the position of the fold.

23. The system of claim 1 wherein the printer is a laser printer and at least one of the following configurations is used for supplying the laser beams to both sides of the paper:
a. At least two lasers sources are used, one for each side of the paper.
b. At least two LED arrays are used, one for each side of the paper.
c. At least one laser source is optically split into at least 2 beams, which are then each separately modulated on/off and rotated by their own optical deflector.
d. At least one laser source is conducted part of the time by optical means to transfer the light to the other side of the paper, so that part of the rotation of the optical deflector runs the laser light over the appropriate pixel-line on the drum on one side of the paper, and another set of angles of rotation runs the light into the optical relay system which correspondingly diverts the laser light to the appropriate position in the pixel-line on the drum on the side of the paper.

24. The method of claim 12 wherein the printer is a laser printer and at least one of the following configurations is used for supplying the laser beams to both sides of the paper:
a. At least two lasers sources are used, one for each side of the paper.
b. At least two LED arrays are used, one for each side of the paper.
c. At least one laser source is optically split into at least 2 beams, which are then each separately modulated on/off and rotated by their own optical deflector.
d. At least one laser source is conducted part of the time by optical means to transfer the light to the other side of the paper, so that part of the rotation of the optical deflector runs the laser light over the appropriate pixel-line on the drum on one side of the paper, and another set of angles of rotation runs the light into the optical relay system which correspondingly diverts the laser light to the appropriate position in the pixel-line on the drum on the side of the paper.

25. The system of claim 1 wherein the paper is held in place also by at least one of:
a. Double-sided tracks at the right and left margins of the paper.
b. Sets of wheels of which at least some are tilted at the side margins so that the wheels both pull the paper forward and sideways.
c. Sets of wheels at the side margins with engraved screw-like spirals so that the wheels both pull the paper forward and sideways.

26. The system of claim 1 wherein the printer is a laser printer and at least one of the following features exists:
a. If there is no paper, the drums are automatically moved a little away from each other so that they don't touch each other in order not to scratch/damage each other.
b. There is a shift between the positions of the two drums, so that the paper does not touch both drums at the same position.
c. There is a shift between the positions of the two drums, so that the paper does not touch both drums at the same position, and between the positions of the two drums there is an additional fixing element, so that the powder on each pixel-line of the 1^{st} side of the paper is already set when the corresponding pixel-line on the other side of the paper enters the second drum.

27. The system of claim 2 wherein the at least two printing heads are positioned in at least one of the following ways:
a. The heads are positioned to the right and to the left of the paper instead of one head above the paper and one head below the paper.
b. The heads are positioned to the right and to the left of the paper instead of one head above the paper and one head below the paper, and the ink containers are similar to an “L” shape for the left head and opposite “L” shape for the right head, so that the heads are at the horizontal ends of the containers and face each other, and the vertical parts can take advantage of normal gravity to move the ink towards the printing elements of the heads.
c. At least one head is above the paper, and at least one head is below the paper and relies on air pressure instead of gravity to direct the ink towards the printing head.
d. At least one head is above the paper and at least one head is below the paper and relies on at least one spring instead of gravity to direct the ink towards the printing head.

28. The system of claim 1 wherein the printer is a laser printer and when printing only on one side at least one of the following configurations exists:
a. All the cartridges in the unused side are automatically moved slightly away from the paper so that it doesn't have to touch it.
b. All the drums in the cartridges in the unused side are automatically moved slightly away from the paper so that it doesn't have to touch it.

29. The system of claim 1 wherein the printer is a solid ink printer which first prints to a drum and then transfers the ink to the paper, and at least one of the following features exists:
a. At least two drums are used next to each other so that the paper can pass between them at the same time and a separate set of solid inks and printing heads is used with each drum.
b. The element that fixes the ink to the paper is as close as possible to the drums in order to avoid smearing.
c. If there is no paper, the drums are automatically moved a little away from each other so that they don't touch each other in order not to scratch/damage each other.
d. There is a shift between the positions of the two drums, so that the paper does not touch both drums at the same position.
e. There is a shift between the positions of the two drums, so that the paper does not touch both drums at the same position, and between the positions of the two drums there is an additional fixing element such as for example a set of rollers that fix the powder by cold pressure, so that the ink on each horizontal line of the 1^{st} side of the paper is already set when the corresponding horizontal line on the other side of the paper enters the second drum.

30. The system of claim 11 wherein the pages are first joined in groups of folded papers, and said groups are later joined together, and said folding is done by inserting a moving element in a slit in a way that pulls and folds the papers in the middle, and at least one of the following features exists:
a. Said slit is a little wider on the top of the tray floor than on the bottom of the floor in order to further help guide the sheets or paper smoothly through the slit.
b. After being pushed through the slit the folded bunches of paper enter a tilted smaller container below the first half of the output tray, so that each time after the pushing element moves out, the newly folded group of papers falls to the side, so that the folded groups of paper lie down stacked on top of each other.
c. Staples can be entered into each bunch of folded papers by an additional side element near the slit.
d. For each book a cover of stronger material is first fed into the bottom compartment so that the upper part of the cover is preferably held in parallel to the wall of said bottom compartment that is near the slit and the bottom part in parallel to the floor of said bottom compartment.

31. The system of claim 30 wherein for each book a cover of stronger material is first fed into the bottom compartment, and at least one of the following features exists:
a. When the moving element pushes down through the slit a folded bunch of papers at the end staples are automatically inserted from below and small sockets at the edge of the moving element cause them to bend and thus stitch the folded bunch of papers together and to the cover.
b. The book cover contains at its central fold a stronger strip with small metal elements like staples, so when the moving element pushes down through the slit a folded bunch of papers it presses against these staples at the end and small sockets at the edge of the moving element cause these staples to bend and thus hold the folded bunches of paper at the fold areas.
c. The book cover contains at its central fold a stronger strip with small plastic hollow needles containing glue at their edges, so that when pressed by the edge of the moving element they penetrate each bunch of papers at the fold area and the parts containing the glue explode and the glue holds it in the inner part of each fold.

32. The system of claim 11 wherein the pages are first joined in groups of folded papers, and said groups are later joined together, and at least one of the following features exists:
a. The book cover contains at its central fold a stronger strip with an adhesive material that can attach to the fold areas of the folded bunches of paper by at least one of pressure and heat.
b. The printer just creates the folded bunches of pages on top of each other and the user then glues them together and adds the cover then.

33. The system of claim 11 wherein the folding is done by Moving part of the tray around a hinge at the center with a horizontal element applied from above the papers, parallel to the hinge, and at least one of the following features exists:
a. At each stage of folding an additional bunch of newly printed papers, the previously folded bunches go down one step into a lower compartment.
b. The book cover is initially attached at both ends to the two edges of the output tray and, at each stage of folding an additional bunch of newly printed papers, the previously folded bunches go down one step into a lower compartment.
c. The book cover contains at its central fold a stronger strip with small metal elements like staples, so these staples are bent by pressing the fold against them.
d. The book cover contains at its central fold a stronger strip with small plastic hollow needles containing glue at their edges, so that when pressing the fold against them they penetrate each bunch of papers at the fold area and the parts containing the glue explode and the glue holds it in the inner part of each fold.
e. Staples are added at the area of the hinge after the folding.
f. Staples are added at the area of the hinge after the folding, so that the staples also stitch the book cover directly to each fold.

34. The system of claim 1 wherein the printer is a solid ink printer which first prints to a drum and then transfers the ink to the paper and wherein elongated printing heads are used, and at least one of the following is done:
a. The ink is heated and liquefied in order to evenly distribute it.
b. Elongated printing heads are used with non-elongated solid inks, so that each time only the tip of the ink is melted and the liquid can flow within at least one of the head and an elongated ink buffer near the head to the positions needed.
c. Said elongated printing heads are the full width of the paper and are stationary.
d. Said elongated printing heads are not the full width of the paper and they do move sideways.
e. Moving non-elongated printing heads are used but they are spread in the direction of the movement of the paper instead of sideways.

35. The system of claim 11 wherein the pages are first joined in groups of folded papers, and said groups are later joined together, and wherein a stripe each paper has a stripe of glue on the middle at the area of the fold and after folding bunches of pages together, the glue binds together both the pages within each bundle and the different bundles to each other and to the cover.

36. The system of claim 1 wherein the printer is a laser printer and at least two cartridges are used next to each other so that the drums are closely facing each other and the paper can pass between at least two drums at the same time, and wherein at least one of the following configurations exists:
a. The cartridges are upright and the drums are at the corners of the cartridges, facing each other, in order to prevent toner from spilling.
b. The cartridges are a little tilted towards each other so that their drums can come into contact.
c. At least one of the drums has a spring in order to improve the contact between the two drums.
d. At least one of the cartridges has a spring in order to improve the contact between the two drums.
e. A number of toner cartridges are used on each side of the paper for color printing

37. The system of claim 1 wherein the printer is a laser printer and at least one cartridge is used to deal with both sides of the paper, so that the paper passes between at least one pair of drums that are connected to the same cartridge, and wherein a number of double-drum toner cartridges are used for color printing

38. The system of claim 8 wherein said gluing is based on covering each page with an appropriate shape and amount of at least one of plastic and adhesive material at the appropriate edge and wherein at least one of the following:
a. The pages are already doped in advance with said adhesive or plastic materials.
b. Said adhesive or plastic materials are added by the printer to each page after it has been printed upon.

39. The system of claim 1 wherein said printer is a laser printer and wherein at least on of the following:
a. The toners on both sides of the paper are fixed simultaneously at the same position.
b. The toner contains also an adhesive element that makes it stick better to the paper independently of the electrical charge.

40. The system of claim 1 wherein said printer is a laser printer and wherein after the fixing elements that set the toner, the paper moves through a position of another type of printing elements that can add color where needed, and at least one of the following features exists:
a. Said color printing elements can print on at least one side of the paper.
b. Said elements that can add color are at least one of inkjet printing heads, solid ink printing heads, and drums coupled to solid ink printing heads.
c. The color printing elements take advantage of the fact that the paper is still hot after exiting the fixing elements that set the toner.
d. The laser unit and the color printing unit work in coordination so that both units can find the exact same positions on the paper and the pixel sizes and margin sizes are sufficiently similar in both units and take into account already also expansion or contraction of the paper and the printer can divide the black printing and the color printing between them as needed.
e. When the percent of black in comparison to color on a certain page is below a certain threshold, the printer can preferably automatically decide to use only the inkjet for that page, in order to achieve more precise mixing.
f. Images and text areas are automatically treated differently, so that the images are automatically assigned to the color printing elements and the text can be printed by one of the units or divided between them.
g. In areas where there is no color the feeder lets the page move much faster, so that the addition of colors only slows down the printing by a minimum percent.
h. At least one of the printer, the user, and software using the printer can automatically decide to convert text to black and send it for the laser unit for printing.
i. The user has the choice of telling the printer to set Off the inkjet part, in which case the printer behaves like a normal laser printer. In all of the above variations, preferably the laser unit is able, when the inkjet option is set to On.
j. The right-left positioning is done by using at the side margins at least one of tiled wheels and wheels with engraved screw-like spirals wherein the tilt is stronger towards one of the sides and there is a border on that side.
k. Sensing is done on at least one of the position of the paper margins and the position of the laser printing, by at least one of at least one reference mark in black and at least one UV mark that is done by an element that is always at the same position in the laser unit, and said sensing can be used to correct the position of the paper and/or the position of the printheads and/or to correct it logically by the printheads.

41. A laser printer wherein after the fixing elements that set the toner, the paper moves through a position of another type of printing elements that can add color where needed, and at least one of the following features exists:
a. Said color printing elements can print on at least one side of the paper.
b. Said elements that can add color are at least one of inkjet printing heads, solid ink printing heads, and drums coupled to solid ink printing heads.
c. The color printing elements take advantage of the fact that the paper is still hot after exiting the fixing elements that set the toner.
d. The laser unit and the color printing unit work in coordination so that both units can find the exact same positions on the paper and the pixel sizes and margin sizes are sufficiently similar in both units and take into account already also expansion or contraction of the paper and the printer can divide the black printing and the color printing between them as needed.
e. When the percent of black in comparison to color on a certain page is below a certain threshold, the printer can preferably automatically decide to use only the inkjet for that page, in order to achieve more precise mixing.
f. Images and text areas are automatically treated differently, so that the images are automatically assigned to the color printing elements and the text can be printed by one of the units or divided between them.
g. In areas where there is no color the feeder lets the page move much faster, so that the addition of colors only slows down the printing by a minimum percent.
h. At least one of the printer, the user, and software using the printer can automatically decide to convert text to black and send it for the laser unit for printing.
i. The user has the choice of telling the printer to set Off the inkjet part, in which case the printer behaves like a normal laser printer. In all of the above variations, preferably the laser unit is able, when the inkjet option is set to On.
j. The right-left positioning is done by using at the side margins at least one of tiled wheels and wheels with engraved screw-like spirals wherein the tilt is stronger towards one of the sides and there is a border on that side.
k. Sensing is done on at least one of the position of the paper margins and the position of the laser printing, by at least one of at least one reference mark in black and at least one UV mark that is done by an element that is always at the same position in the laser unit, and said sensing can be used to correct the position of the paper and/or the position of the printheads and/or to correct it logically by the printheads.
